(19) United States
(12) Patent Application Publication
(10) Pub. No.: US 2026/0239064 A1
(43) Pub. Date: Aug. 13, 2026

(54) CHANNEL STATE INFORMATION FEEDBACK ON MULTIPLE CHANNEL MEASUREMENT RESOURCES OR COHERENT JOINT TRANSMISSIONS

(71) Applicant: Google LLC, Mountain View, CA (US)

(72) Inventors: Yushu Zhang, Beijing (CN); Chih-Hsiang Wu, Taipei (TW); Jia-Hong Liou, Taipei (TW)

(21) Appl. No.: 19/103,177

(22) PCT Filed: Aug. 12, 2022
(86) PCT No.: PCT/CN2022/112307

§ 371 Date: Feb. 11, 2025

(51) Int. Cl. H04W 24/10; H04B 7/06; H04L 5/00; H04W 72/51; H04W 72/541

(52) U.S. Cl. CPC H04W 24/10; H04B 7/0626; H04L 5/0035; H04L 5/0057; H04W 72/51; H04W 72/541

(57) ABSTRACT

This disclosure provides methods and systems for wireless communications of channel state information (CSI) feedback on multiple channel measurement resources (CMRs) or coherent joint transmissions (CJT). For example, a user equipment (UE) transmits, to a network entity, an indication of a capability of reporting a CSI report based on multiple CMRs or signals of multiple transmission/reception points (TRPs). The UE then receives a configuration message that configures the UE to determine the CSI report. The UE performs concurrent measurements of the multiple CMRs and at least one interference measurement resource (IMR) for a number of time instances by the UE as configured according to the configuration message. The UE prepares, based on the concurrent measurements, a single CSI report that reflects time domain variation for two or more of the multiple CMRs. The UE transmits, to the network entity, the single CSI report comprising the concurrent measurements performed.

### TECHNICAL FIELD

The present disclosure relates generally to channel state information (CSI) feedback.

### BACKGROUND

The Third Generation Partnership Project (3GPP) is currently in the process of specifying a new Radio Interface called 5G New Radio (5G NR) as well as a Next Generation Packet Core Network (NG-CN or NGC). The 5G NR architecture will have three components: a 5G Radio Access Network (5G-RAN), a 5G Core Network (5GC), and a User Equipment (UE). In order to facilitate the enablement of different data services and requirements, the 3GPP 5G NR cellular network supports network slicing, which enables the multiplexing of virtualized and independent logical networks on the same physical network infrastructure.

Channel state information (CSI) can be obtained from measurements based on a single CSI-RS instance, or an averaging of multiple CSI-RS instances. Such kind of CSI cannot reflect the time domain variation for the channel. Such CSI reporting mechanism may not work well for UEs with high/medium velocities as the single CSI-RS instance may not provide sufficient information for ascertaining dynamic aspects of channel conditions (e.g., UE moving at 30 km/h or beyond).

On the other hand, when multiple transmission/reception points (TRPs) are involved, configuring the CSI framework to support CSI report for coherent joint transmission (CJT) of multiple TRPs may face technical problems and challenges.

### SUMMARY

The present disclosure provides methods for channel state information (CSI) feedback for user equipments (UEs) with high and medium velocities, including:
Control signaling to trigger multiple instances for aperiodic CSI-RS for CSI measurement
Methods to identify the time instances for CSI measurement
Methods to determine the LI and CQI reported in the CSI

In addition, the present disclosure provides methods for CSI feedback for coherent joint transmission (CJT), including:
CSI framework for CSI report for CJT operation
CSI processing unit (CPU) occupancy rule and minimal processing delay for CSI report for CJT operation

Details of the methods (as well as related systems and techniques) are discussed in detail below.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example framework for channel state information (CSI), according to some embodiments;

FIG. 2 is an example depicting CSI processing unit (CPU) occupancy rule for periodic or semi-persistent CSI report, according to some embodiments;

FIG. 3 is an example depicting CSI processing unit (CPU) occupancy rule for aperiodic CSI report, according to some embodiments;

FIG. 4 illustrates an example mechanism for a singular CSI report of multiple CSI measurements for high or medium speed UEs, according to some embodiments;

FIG. 5 is a flow diagram depicting a method of wireless communications by a user equipment (UE) device, according to some embodiments;

FIG. 6 illustrates an example call flow diagram of enhancing aperiodic CSI feedback to support a UE device with high/medium velocity, according to some embodiments;

FIG. 7 illustrates an example scheme with time domain interpolation, according to some embodiments;

FIG. 8 is a flow diagram depicting a method of wireless communications by a user equipment (UE) device, according to some embodiments;

FIG. 9 is a flow diagram depicting a method of wireless communications by a network entity, according to some embodiments;

FIG. 10 illustrates an example call flow diagram of enhancing aperiodic and semi-persistent CSI feedback to support a UE device with high/medium velocity, according to some embodiments;

FIG. 11 is an example depicting coherent joint transmission (CJT), according to some embodiments;

FIG. 12 is a flow diagram depicting a method of CJT CSI reporting by a user equipment (UE) device, according to some embodiments;

FIG. 13 illustrates an example call flow diagram of CJT CSI reporting, according to some embodiments;

FIG. 14 is a flow diagram depicting a method of CJT CSI reporting by a user equipment (UE) device, according to some embodiments;

FIG. 15 is a flow diagram depicting a method of CJT CSI reporting by a network entity, according to some embodiments;

FIG. 16 illustrates an example for CSI framework for CMR/IMR configuration and association for CJT-CSI report, according to some embodiments;

FIG. 17 illustrates an example for CSI framework for CMR/IMR configuration and association for CJT-CSI report, according to some embodiments;

FIG. 18 illustrates an example for CSI framework for CMR/IMR configuration and association for CJT-CSI report, according to some embodiments; and

FIG. 19 illustrates an example for aperiodic CSI trigger state configuration, according to some embodiments.

### DETAILED DESCRIPTION

For ease of illustration, the following techniques are described in an example context in which one or more UE devices and RANs implement one or more radio access technologies (RATs) including at least a Fifth Generation (5G) New Radio (NR) standard (e.g., Third Generation Partnership Project (3GPP) Release 15, 3GPP Release 16, etc.) (hereinafter, “5G NR” or “5G NR standard”). However, the present disclosure is not limited to networks employing a 5G NR RAT configuration, but rather the techniques described herein can be applied to any combination of different RATs employed at the UE devices and the RANs. Also, the present disclosure is not limited to the examples and context described herein, but rather the techniques described herein can be applied to any network environment.

This disclosure provides methods and systems for wireless communications of channel state information (CSI) feedback on multiple channel measurement resources (CMRs) or coherent joint transmissions (CJT). For example, a user equipment (UE) transmits, to a network entity, an indication of a capability of reporting a CSI report based on multiple CMRs or signals of multiple transmission/reception points (TRPs). The UE then receives a configuration message that configures the UE to determine the CSI report. The UE performs concurrent measurements of the multiple CMRs and at least one interference measurement resource (IMR) for a number of time instances by the UE as configured according to the configuration message. The UE prepares, based on the concurrent measurements, a single CSI report that reflects time domain variation for two or more of the multiple CMRs. The UE transmits, to the network entity, the single CSI report comprising the concurrent measurements performed.

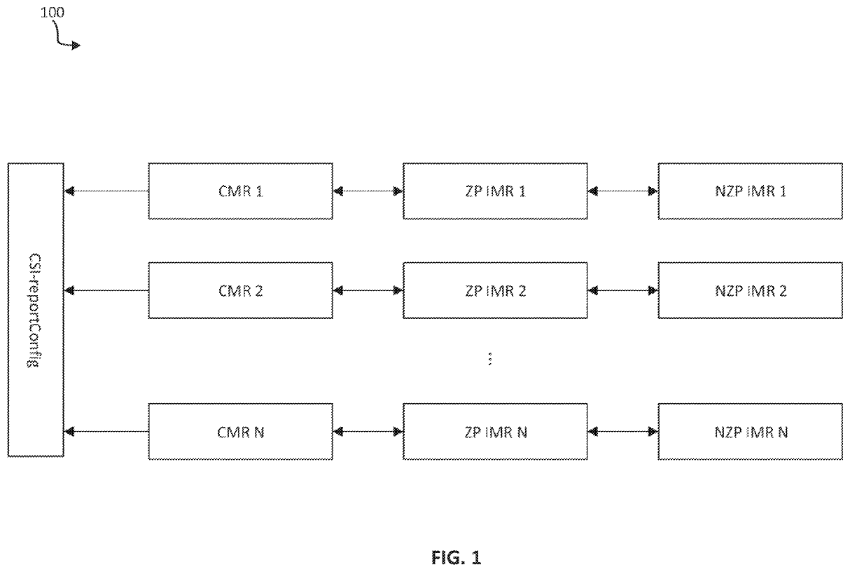

FIG. 1 is a block diagram 100 depicting an example framework 100 for channel state information (CSI), according to some embodiments. For Multiple-Input Multiple-Output (MIMO) system, the channel state information (CSI) is a key information for gNB to select the digital precoder for a UE. Usually gNB can configure a CSI report by RRC signaling CSI-ReportConfig, where channel state information reference signal (CSI-RS) is used as channel measurement resource (CMR) for UE to measure the downlink channel. Meanwhile, gNB may configure some interference measurement resource (IMR) for UE to measure interference in a CSI-ReportConfig. One CMR, e.g., one resource configured in resourcesForChannelMeasurement could be associated with one zero power IMR (ZP-IMR), e.g., one resource configured in csi-IM-ResourcesForInterference, and/or non-zero-power IMR (NZP-IMR), e.g., one resource configured in nzp-CSI-RS-ResourcesForInterference. In one example, NZP-IMR can be used for intra-cell interference measurement and ZP-IMR can be used for inter-cell interference measurement. For a UE with multi-beam operation, the UE should use the same beam to receive the CMR as well as the associated IMR(s).

With the help of the associated CMR and IMR(s), UE is able to identify the CSI, which may include rank indicator (RI), precoder matrix indicator (PMI), channel quality indicator (CQI) and layer indicator (LI). RI and PMI are used to determine the digital precoder, CQI is used to reflect the signal-to-interference plus noise (SINR) status so as to assist gNB to determine the modulation and coding scheme (MCS), and LI is used to identify the strongest layer, which can be helpful for MU-MIMO paring with low rank transmission and the precoder selection for phase-tracking reference signal (PT-RS). For a CSI-ReportConfig with more than 1 CMRs configured, UE may report the CSI-RS resource indicator (CRI) associated with the reported RI/PMI/CQI/LI to inform gNB from which CMR the CSI is measured.

The gNB can configure the time domain behavior, e.g., periodic/semi-persistent/aperiodic report, for a CSI report in a CSI-ReportConfig. The gNB can activate or deactivate a semi-persistent CSI report by MAC control element (CE). The gNB can trigger an aperiodic CSI report by Downlink Control Information (DCI). UE may report the periodic CSI by a PUCCH resource configured in CSI-ReportConfig. UE may report the semi-persistent CSI by a PUCCH resource configured in CSI-ReportConfig or PUSCH resource triggered by DCI by gNB. UE may report the aperiodic CSI by a PUSCH resource triggered by DCI by gNB.

For layer 1 related measurement, the following types of CSI-RSs have been introduced since Rel-15:

CSI-RS for tracking, which is also called as tracking reference signal (TRS). It is a CSI-RS resource set with RRC parameter TRS-Info configured. The TRS is used for time/frequency offset tracking.

CSI-RS for beam management (BM). The CSI-RS for BM is configured in a CSI-RS resource set with RRC parameter repetition configured.

CSI-RS for CSI acquisition. This is a CSI-RS used for CSI measurement and report. The CSI-RS for CSI acquisition is configured in a CSI-RS resource set without RRC parameters TRS-Info and repetition configured.

In this disclosure, unless specified, the CSI-RS indicates the CSI-RS for CSI acquisition.

Since Rel-15, the Type 2 CSI codebook for CSI report has been introduced for UE to measure and report the CSI, where a precoder is quantized as follows:

$$W = {W}_{1} {W}_{2}$$

Where W₁ is a wideband precoder with the dimension of N_{Tx} by 2L; W₂ is a subband precoder with the dimension of 2L by ν; L indicates the number of beams, and ν indicates the number of layers, which is RI+1.

W₁ can be quantized based on a codebook, while W₂ could be quantized based on power and angle for each element, which could lead to a large overhead since W₂ is subband based, and there could be multiple subbands for a CSI report, which is determined by the bandwidth for the CSI-RS. In one example, the codebook for W1 selection can be defined as follows:

$${W}_{1} = [ \begin{matrix}B & 0 \\ 0 & B\end{matrix} ] \\ B = [ {b}_{1} {b}_{2} … {b}_{L} ] \\ {b}_{l} = {u}_{m} ⊗ {v}_{n} \\ {u}_{m} = {[ 1 {e}^{\frac{j 2 π m}{{N}_{1} {O}_{1}}} … {e}^{\frac{j 2 π ( {N}_{1} - 1 ) m}{{N}_{1} {O}_{1}}} ]}^{T} \\ {v}_{n} = {[ 1 {e}^{\frac{j 2 π n}{{N}_{2} {O}_{2}}} … {e}^{\frac{j 2 π ( {N}_{2} - 1 ) n}{{N}_{2} {O}_{2}}} ]}^{T}$$

Where, ⊗ denotes Kronecker product; L indicates number of beams which are configured by RRC signaling; N₁, N₂, O₁, and O₂ are related to the number of ports and oversampling factor in horizontal and vertical domain, which are configured by RRC signaling, and the candidate values should be determined based on number of CSI-RS ports. The codebook contains the precoders with different value of m and n. In one example, candidate values are defined as Table 5.2.2.2.1-2 in 38.214.

In Rel-16, an enhanced Type2 codebook for a CSI report for a TRP is introduced, where the precoder can be quantized as follows:

$$W = {W}_{1} {\tilde{W}}_{2} {W}_{f}^{H}$$

Where, W₁ is the same as Rel-15 Type2 codebook, which is used to provide the spatial domain basis (SD-basis); \tilde{W}₂ indicates a wideband beam combining weight with the dimension of 2L by M, and W_{f} indicates a frequency domain basis (FD-basis) with the dimension of N₃ by M, where N₃ is the number of subbands and can be derived by RRC parameter numberOfPMI-SubbandsPerCQI-Subband, and M can be derived by RRC signaling numberOfPMI-SubbandsPerCQI-Subband and paramCombination. Details can be found at section 5.2.2.2.5 in 38.214.

A UE may be configured with multiple CSI-ReportConfig for multiple CSI measurement and report. With regard to multiple parallel CSI measurement and report processing, a CSI processing unit (CPU) has been introduced since Rel-15. A UE can report how many CPUs it support, and if the gNB's scheduling leads to more parallel CSI processing than supported number of CPUs, UE can report outdated CSI for the low priority CSI report(s), where the priority is calculated according to section 5.2.5 in 38.214. The CPU occupancy rule for periodic/semi-persistent/aperiodic CSI report is defined as follows [38.214, section 5.2.1.6].

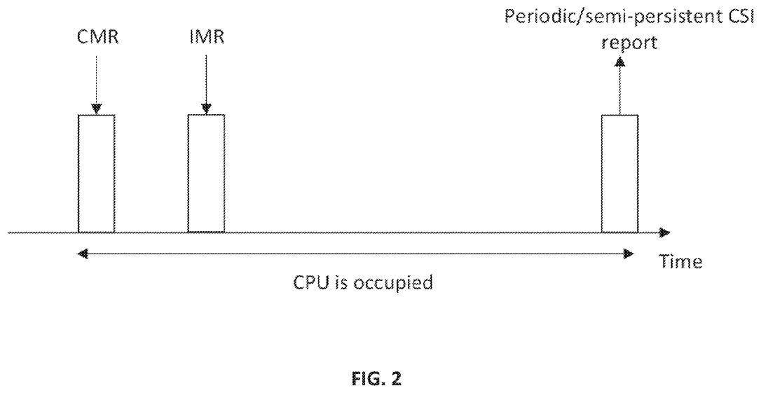

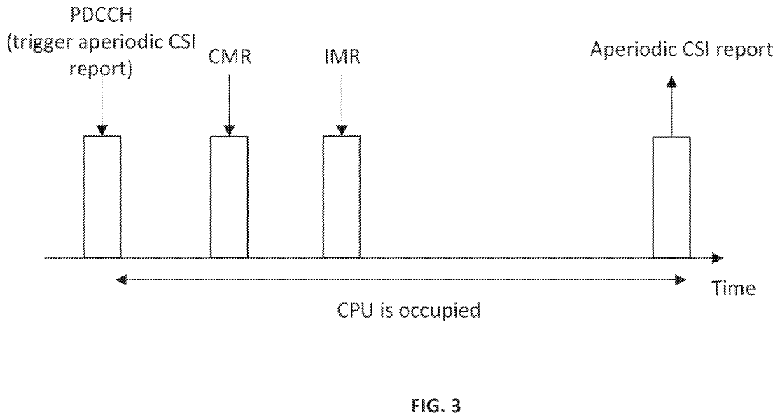

FIG. 2 is an example depicting CSI processing unit (CPU) occupancy rule for periodic or semi-persistent CSI report. FIG. 3 is an example depicting CSI processing unit (CPU) occupancy rule for aperiodic CSI report. A periodic or semi-persistent CSI report (excluding an initial semi-persistent CSI report on PUSCH after the PDCCH triggering the report) occupies CPU(s) from the first symbol of the earliest one of each CSI-RS/CSI-IM/SSB resource for channel or interference measurement, respective latest CSI-RS/CSI-IM/SSB occasion no later than the corresponding CSI reference resource, until the last symbol of the configured PUSCH/PUCCH carrying the report.

An aperiodic CSI report occupies CPU(s) from the first symbol after the PDCCH triggering the CSI report until the last symbol of the scheduled PUSCH carrying the report. When the PDCCH reception includes two PDCCH candidates from two respective search space sets, as described in clause 10.1 of [6, TS 38.213], for the purpose of determining the CPU occupation duration, the PDCCH candidate that ends later in time is used.

An initial semi-persistent CSI report on PUSCH after the PDCCH trigger occupies CPU(s) from the first symbol after the PDCCH until the last symbol of the scheduled PUSCH carrying the report. When the PDCCH reception includes two PDCCH candidates from two respective search space sets, as described in clause 10.1 of [6, TS 38.213], for the purpose of determining the CPU occupation duration, the PDCCH candidate that ends later in time is used.

In addition, two minimal processing delays for a CSI report are defined as follows, where the scheduling for the CSI report should follow the minimal processing delay Z and Z′. The candidate value for Z and Z′ for different types of CSI report is defined in section 5.4 in 38.214. If the scheduling offset does not follow the minimal Z and Z′, UE can report an outdated CSI or ignore the DCI if no other signals, e.g., data and HARQ-ACK, are to be transmitted on the PUSCH triggered by the DCI.

When the CSI request field on a DCI triggers a CSI report(s) on PUSCH, the UE shall provide a valid CSI report for the n-th triggered report,
if the first uplink symbol to carry the corresponding CSI report(s) including the effect of the timing advance, starts no earlier than at symbol Z_{ref}, and
if the first uplink symbol to carry the n-th CSI report including the effect of the timing advance, starts no earlier than at symbol Z′_{ref}(n),

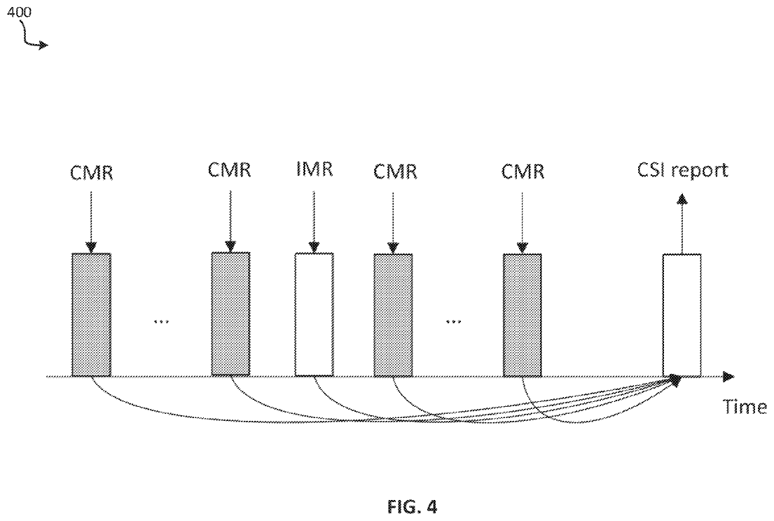

FIG. 4 illustrates an example mechanism 400 for a singular CSI report of multiple CSI measurements for high or medium speed UEs, according to some embodiments. The CSI enhancement for a UE with a high/medium velocity, e.g., the UE with moving speed above 30 km/h (or a threshold velocity) relative to a network entity (e.g., a BS), may be used, where the UE may perform measurements on multiple CMR instances and report the CSI based on the measurements as shown.

As UE's location would not change within a short time, e.g., several slots, the SD/FD basis would not change, then only the beam combining weight could change. For CMR instance t, the UE may select the precoder as

$${W}_{t} = {W}_{1} {\tilde{W}}_{2}^{t} {W}_{f}^{H}$$

The selected precoder for the N₄ CMR instances at t_{-N4+1}, t_{-N4+2}, . . . t₀ can be denoted as follows:

$$W = [ \begin{matrix}{W}^{{t}_{- {N}_{4} + 1}} & {W}^{{t}_{- {N}_{4} + 2}} & … & {W}^{{t}_{0}}\end{matrix} ]$$

$$W = [ \begin{matrix}{W}_{1} {\tilde{W}}_{2}^{{t}_{- {N}_{4} + 1}} {W}_{f}^{H} & {W}_{1} {\tilde{W}}_{2}^{{t}_{- {N}_{4} + 2}} {W}_{f}^{H} & … & {W}_{1} {\tilde{W}}_{2}^{{t}_{0}} {W}_{f}^{H}\end{matrix} ]$$

Then the precoder W can be compressed as follows

$$W = {W}_{1} {\hat{W}}_{2} ( {W}_{td}^{H} ⊗ {W}_{f}^{H} )$$

Where W_{td} indicates a matrix with T time domain basis (TD basis) with the dimension of N₄ by T; Ŵ₂ indicates the new beam combining weight for the N₄ CMR instances with the dimension of 2L by M*T. The TD basis may also be denoted as Doppler domain basis (DD basis).

For CSI measurement in high/medium velocity, the first issue is about the control signaling to trigger multiple instances for aperiodic CSI-RS when the CMR is configured as CMR for the CSI feedback. The second issue is how to maintain the same understanding between gNB and UE about the time instances for a CSI feedback. The third issue is how to calculate other CSI component, e.g., LI, CQI, based on the measured precoder and channel for multiple instances.

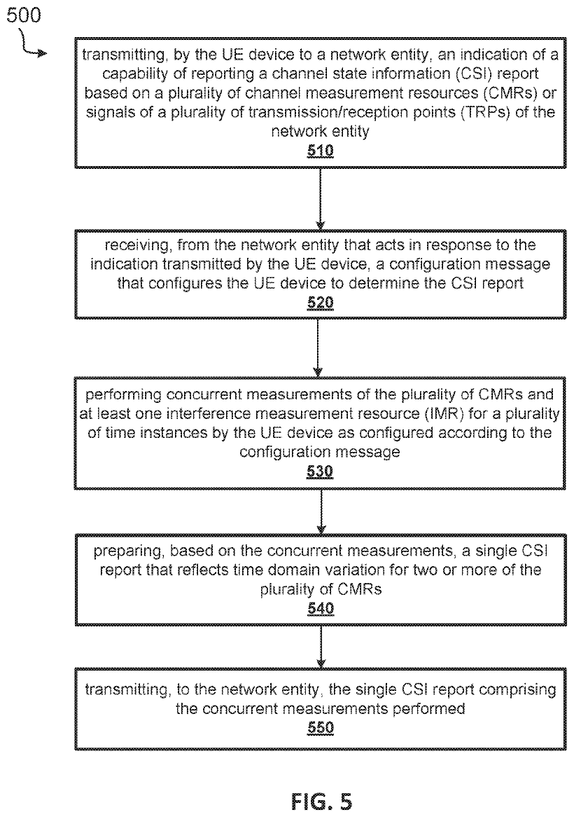

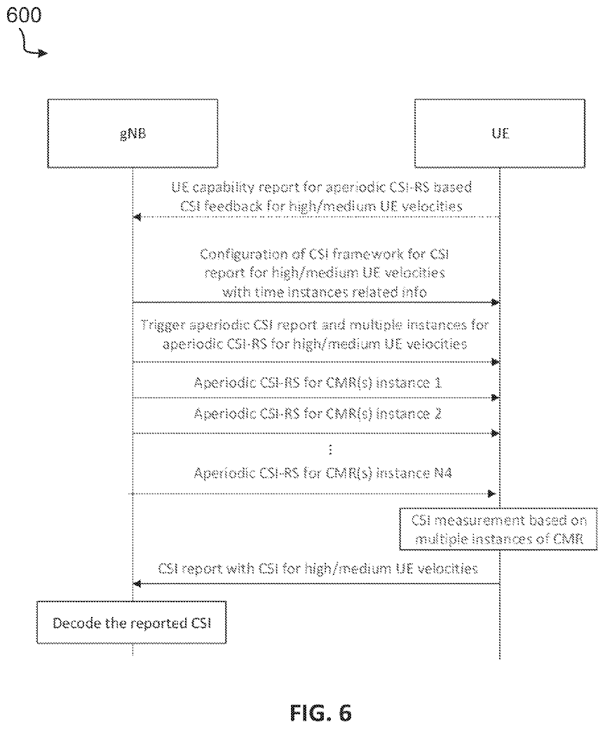

FIG. 5 is a flow diagram depicting a method 500 of wireless communications by a user equipment (UE) device, according to some embodiments. The method is performed by processing logic that includes hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. The method of the flow diagram 500 is performed by a UE device. The network entity may include one or more radio frequency (RF) modems, a processor coupled to the one or more RF modems, and at least one non-transient memory storing executable instructions to manipulate at least one of the processor or the RF modems to perform the method of the flow diagram 500. A network entity may perform a complimentary method to interact with the UE device performing the method 500 (see call flow diagram in FIG. 6).

With reference to FIG. 5, method illustrates example functions used by various embodiments. Although specific function blocks (“blocks”) are disclosed in method, such blocks are examples. That is, embodiments are well suited to performing various other blocks or variations of the blocks recited in method. It is appreciated that the blocks in method may be performed in an order different than presented, and that not all of the blocks in method may be performed.

As shown in FIG. 5, the method includes the block 510 of transmitting, by the UE device to a network entity, an indication of a capability of reporting a channel state information (CSI) report based on multiple channel measurement resources (CMRs) or signals of multiple transmission/reception points (TRPs) of the network entity.

The method includes the block 520 of receiving, from the network entity that acts in response to the indication transmitted by the UE device, a configuration message that configures the UE device to determine the CSI report.

The method includes the block 530 of performing concurrent measurements of the multiple CMRs and at least one interference measurement resource (IMR) for multiple time instances by the UE device as configured according to the configuration message.

The method includes the block 540 of preparing, based on the concurrent measurements, a single CSI report that reflects time domain variation for two or more of the multiple CMRs.

The method includes the block 550 transmitting, to the network entity, the single CSI report including the concurrent measurements performed.

In some aspects, the method 500 further includes decoding, multiple instances of CSI reference signals (CSI-RSes) including one or more of: CMRs, IMRs, and time instances for CSI measurements, with a codebook configured for CSI measurements based on the configuration message from the network entity. The method 500 may also include obtaining a precoder value based on at least a layer indicator (LI) or a channel quality indicator (CQI) corresponding to each of the two or more of the multiple CMRs and the at least one IMR; and transmitting the CSI report to the network entity, the CSI report including the precoder and one or both of the LI and CQI.

In some embodiments, the method 500 may include performing concurrent measurements on the multiple CMRs and the at least one IMR at the multiple time instances. The method may include determining or generating a single CSI report that reflects time domain variation for each of the two or more of the multiple CMRs when the UE device exceeds a threshold velocity. The UE device may transmit the single CSI report to the network entity.

In some embodiments, the configuration message includes at least one of: a radio resource control (RRC) message; a medium access control (MAC) control element (MAC CE); or a downlink control information (DCI). The plurality of instances of CSI-RSes includes aperiodic or semi-persistent CSI-RSes.

In some embodiments, the indication of the capability of reporting the CSI report includes any of: a maximum number of instances of CSI-RS resources that the UE device is capable of measuring for the CSI report; number of CSI processing units (CPUs) occupied for CSI-RS with multiple instances; an upper limit of a number of information elements (IEs) for CSI report configuration; a minimal processing delay for the CSI report; and whether to support CSI prediction of CSI measurements based on virtual CMR instances.

In some embodiments, the method 500 may further include receiving a downlink control information (DCI) from the network entity for triggering the multiple CMRs and the at least one IMR, the multiple CMRs including the plurality instances of CSI-RSes.

In some embodiments, the UE device may obtain the precoder by: identifying the instances of the CSI-RSes as the CMRs; and performing CSI measurements on the instances of CSI-RSes.

In some embodiments, the configuration message may include: a number indicating the multiple instances of CSI-RSes for use in the CSI report; a number of time domain basis; and a scheme for CSI measurements. The scheme for CSI measurements may include a scheme that is based on multiple virtual CMRs and multiple physical CMRs measured before a minimal processing delay for the CSI report.

In some cases, the method 500 may further include transmitting the CSI report to the network entity, the CSI report including multiple measurements of the LI and CQI based on: (1) CMRs with the most energy among the multiple CMRs or the least energy among the multiple CMRs; (2) a respective performance of one or more CMRs among the multiple CMRs; (3) the precoder; (4) a minimal value and a maximal value of CQIs; or (5) correspondence to a first instance and a last instance of the multiple CMRs. In some cases, the codebook is for decoding aperiodic CSI-RSes that are used by the UE device to report the CSI report when the UE device travels at a velocity relative to the network entity no less than a threshold velocity.

FIG. 6 illustrates an example call flow diagram 600 of enhancing aperiodic CSI feedback to support a UE device with high/medium velocity, according to some embodiments. Initially, a UE may report to a gNB one or more capabilities indicating support of enhanced aperiodic CSI feedback, e.g., maximum number of instances of aperiodic CSI-RS resource that the UE can measure for the enhanced CSI feedback. In some embodiments, the gNB can receive the one or more capabilities from a core network (e.g., Access and Mobility Management Function (AMF)) or another gNB. After receiving the capability, the gNB may send the UE a RRC message (e.g, RRCReconfiguration message or RRCResume message) including a configuration enabling the enhanced aperiodic CSI feedback. In some implement, the gNB can include the configuration in a CSI-ReportConfigReportConfig IE and include the CSI-ReportConfig IE in the RRC message. After transmitting the configuration to the UE, the gNB may transmit a DCI to the UE to trigger multiple instances of aperiodic CSI-RS configured as CMR. Then the UE may perform measurements on multiple instances of the aperiodic CSI-RS. The UE obtains or derives a channel estimation and/or signal to signal-to-interference plus noise (SINR) from the measurements. The UE selects a precoder matrix W (i.e., a component of CSI), and selects other components of CSI, e.g., LI and CQI based on the selected precoder matrix as well as the channel estimation. Finally, the UE reports the CSI (i.e., the components described above) to the gNB and the gNB performs CSI decoding.

In an embodiment, the one or more capabilities include at least one of the following capabilities:
1) a maximum number of instances for an aperiodic CSI-RS resource that the UE can measure and obtain CSI for the enhanced aperiodic CSI feedback,
2) a maximum number of CSI-ReportConfigReportConfig IEs with aperiodic CSI-RS,
3) the number of CPUs occupied for aperiodic CSI-RS with multiple instances, and
4) a minimal processing delay defined by parameters Z and Z′ for a CSI report based on aperiodic CSI-RS with multiple instances,
5) whether to support CSI prediction, e.g., CSI measurement based on virtual CMR instances.

Each, some or all of the one or more capabilities above can be defined or specified per bandwidth part (BWP), per band, per band combination, or per component carrier (CC) or across CCs in a band combination.

In an embodiment, the configuration for the enhanced aperiodic CSI feedback or the CSI-ReportConfig can include a new codebook configuration for a codebookCSI-ReportConfig. The new codebook configuration may include at least one of the following configuration parameters:
Number of beams (L)
Number of ports in horizontal and vertical domain (N1, N2)
Number of oversampling factors in horizontal and vertical domain (O1, O2)
Number of subbands per CQI calculation, which indicates the number of subbands for CSI compression used for CQI calculation
RI restriction, which is used to indicate the candidate ranks for precoder selection
Number of CMR instances for CSI report, which indicates value of N4
Number of time domain basis, which indicates the value of T
CSI measurement scheme

In some implementations, the number of CMR instances may be determined based on the number of instances for the triggered aperiodic CSI-RS configured as CMR. For example, if gNB triggers N4 instances of aperiodic CSI-RS, the number of CMR instances is N4. The details on triggering more than 1 instances for an aperiodic CSI-RS is illustrates in the next embodiment. Thus the RRC parameter on number of CMR instances may not be provided for aperiodic CSI-RS based CSI report.

In some implementations, with regard to dynamic switching between legacy codebooks and new codebooks for the enhanced aperiodic CSI feedback, in some implementations, the gNB may dynamically update or configure the number of instances (N4) by L1 or L2 signaling, e.g., a MAC CE or DCI. For example, the gNB includes a N4 value in the configuration (i.e., RRC configuration) for the enhanced aperiodic CSI feedback and transmits a MAC CE or DCI including a new N4 value to the UE to update the N4 value configured in the RRC configuration. In another example, the gNB transmits a MAC CE or DCI including a N4 value to the UE instead of transmitting a RRC message including the N4 to the UE. In this example, the configuration for the enhanced aperiodic CSI feedback does not include the number of instances (N4).

In some other implementations, the number of instances (N4) may be reported by the UE to the gNB. In one implementation, the UE determines the number of instances which is smaller than or equal to the number of instances configured by the gNB. In one example, in a CSI report, the UE may include the value of N4 and the CSI components based on the reported N4. If the UE uses a long PUCCH format or PUSCH to transmit the CSI report, the UE includes the N4 value in CSI part 1 in the CSI report. If the UE uses a short PUCCH format to transmit the CSI report, the UE may not include the N4 value in the CSI report. Table 1 illustrates one example for the CSI part 1 in the CSI report. In some embodiments, the UE includes the value of N4 in CSI part 2 in the CSI report.

TABLE 1
One example for CSI report with number of instances

| CSI report | |
|---|---|
| number | CSI fields |
| CSI report #n | CRI, if reported |
| CSI part 1 | Rank Indicator, if reported |
| | Wideband CQI, if reported |
| | Subband differential CQI, if reported |
| | The number of CMR instances, |
| | if reported |

The “CSI measurement scheme” may configure UE to select one of the following schemes to identify the N4 time instances for the CSI report.

Scheme 1: The reported CSI should be measured based on the N4 instances for CMRs before the minimal processing delay for the CSI report

Scheme 2: The reported CSI should be measured based on a virtual N4 CMR instances and the actual CMRs before the minimal processing delay for the CSI report

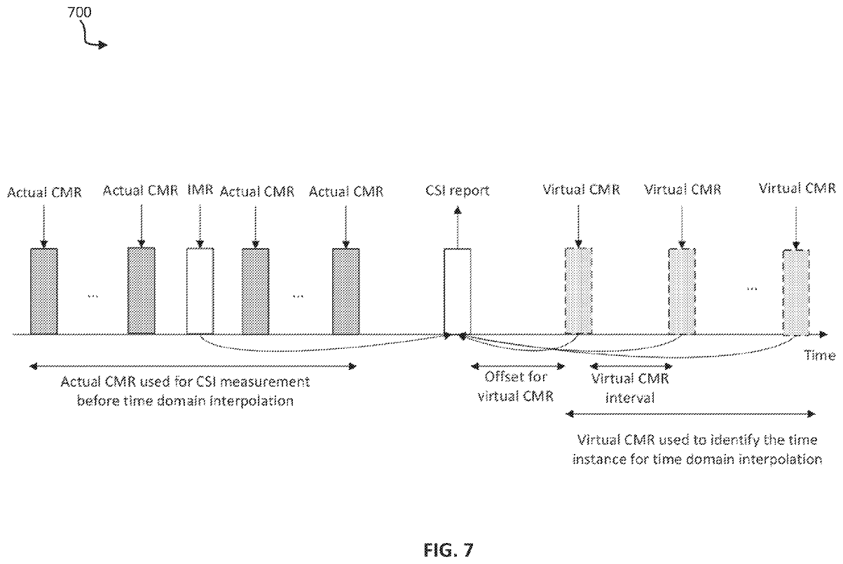

FIG. 7 illustrates an example scheme 700 with time domain interpolation, according to some embodiments. For scheme 2, UE needs to apply time domain interpolation as shown. Some additional parameters as follows may be predefined or configured by RRC signaling in the CSI-ReportConfig.

Starting offset for the first virtual CMR instance for CSI measurement, which is used to indicate the time domain location of starting CMR instances with the first or last symbol of the CSI report as reference

Interval for the virtual CMR instances for CSI measurement, which is used to indicate the interval between each virtual CMR instance

Number of actual CMR instances for CSI measurement, which is used to indicate the actual CMR instances for CSI measurement before the time domain interpolation.

In one example, the starting offset for the virtual CMR instance may be predefined as the slot with CSI report or X slots after the first/last symbol of the CSI report. The virtual CMR interval may be predefined as X slots. The value of X may be the same as the interval for actual CMR. The number of actual CMR instances may be the same as the number of instances for the triggered aperiodic CSI-RS for CSI measurement. In some other implementation, the CSI measurement scheme on CMR instances selection may be reported by UE. In one example, in a CSI report, the UE may report the CSI measurement scheme on CMR instances selection.

In an embodiment, the gNB may trigger multiple instances for an aperiodic CSI-RS by DCI, e.g., DCI format 0_1 or 0_2.

In one implementation, for a CSI-RS resource, the gNB may configure the number of instances and interval between two consecutive instances by RRC signaling, RRC parameter in NZP-CSI-RS-Resource. Then when such CSI-RS resource is triggered by the DCI, e.g., by DCI field CSI request, the gNB may transmit the CSI-RS in the configured instances, where the time domain location for the first instance is configured by RRC signaling. In one example, the following RRC parameters nrofInstances and instanceInterval can be introduced to provide multi-instance aperiodic CSI-RS configuration.

```
NZP-CSI-RS-Resource ::= SEQUENCE {
  nzp-CSI-RS-ResourceId NZP-CSI-RS-ResourceId,
  resourceMapping CSI-RS-ResourceMapping,
  powerControlOffset INTEGER (−8..15),
  powerControlOffsetSS ENUMERATED{db-3, db0, db3, db6} OPTIONAL, -- Need R
  scramblingID ScramblingId,
  periodicityAndOffset CSI-ResourcePeriodicityAndOffset OPTIONAL,
  -- Cond PeriodicOrSemiPersistent
  qcl-InfoPeriodicCSI-RS TCI-StateId OPTIONAL, -- Cond Periodic
    nrofInstances INTEGER (2...8) OPTIONAL,
    instanceInterval INTEGER (2...14) OPTIONAL,
    ...
}
```

In another implementation, the gNB may trigger multiple instances for a CSI-RS by triggering a set of CSI-RS with CSI-RS resources with the same configuration by DCI, e.g., DCI field CSI request. In a CSI-RS resource set, an RRC parameter may be introduced to indicate the CSI-RSs are from the same port and/or another RRC parameter may be introduced to provide the interval between two CSI-RS resources. In one example, the following RRC parameters samePort and instanceInterval can be introduced to provide multi-instance aperiodic CSI-RS configuration. For CSI-RS resources in the resource set, the RRC parameters other than nzp-CSI-ResourceId should be the same, or the RRC parameters configured for the CSI-RS resource with lowest ID should be applied to all the CSI-RS resources in the resource set.

```
NZP-CSI-RS-ResourceSet ::= SEQUENCE {
  nzp-CSI-ResourceSetId NZP-CSI-RS-ResourceSetId,
  nzp-CSI-RS-Resources SEQUENCE (SIZE (1..maxNrofNZP-CSI-RS-ResourcesPerSet)) OF NZP-CSI-
RS-ResourceId,
  repetition ENUMERATED { on, off } OPTIONAL, -- Need S
  aperiodicTriggeringOffset INTEGER (0..6) OPTIONAL, -- Need S
  trs-Info ENUMERATED {true} OPTIONAL, -- Need R
  ...,
  [ [
  aperiodicTriggeringOffset-r16 INTEGER (0..31) OPTIONAL -- Need S
  ] ],
  [ [
  pdc-Info-r17 ENUMERATED {true} OPTIONAL, -- Need R
  cmrGroupingAndPairing-r17 CMRGroupingAndPairing-r17 OPTIONAL --
Need R
    ] ]
    samePort ENUMERATED {true} OPTIONAL
    instanceInterval INTEGER (2...14) OPTIONAL,
}
```

In another implementation, the gNB may configure the number of instances and/or interval between two consecutive instances for the triggered aperiodic CSI-RS resource(s) by DCI used to triggered the aperiodic CSI-RS resource(s). In one example, one field number of instance may be introduced in the DCI. In another example, one field interval between two consecutive instances for a CSI-RS may be introduced in the DCI.

In an embodiment, after receiving the signaling to trigger the CSI report for high/medium UE velocities, UE may select the precoder for the target time instances as follows

$$W = {W}_{1} {\hat{W}}_{2} ( {W}_{td}^{H} ⊗ {W}_{f}^{H} )$$

In one implementation, UE may measure and report LI/CQI corresponding to one CMR instance. The UE may report the LI/CQI based on the precoder for the first or last CMR instance. In some embodiments, UE may report the LI/CQI based on the CMR instance that is the most closed to the CSI report or IMR. In some embodiments, UE may report the LI/CQI based on the CMR instance with the best or worst energy/performance among the CMR instances. In some embodiments, the CMR instance may be configured by gNB based on RRC signaling, MAC CE or DCI. In some embodiments, the CMR instance index to derive LI/CQI may be reported by UE in the CSI report. The CMR instance may be actual CMR instance or virtual CMR instance.

In another implementation, UE may measure and report multiple LIs/CQIs corresponding to multiple CMR instance. The UE may report the LI/CQI based on the precoder for each CMR instance. In some embodiments, UE may report two LIs/CQIs based on the CMR instances, which denotes the minimal CQI and maximum CQI measured among the CMR instances, and LI measured from these CMR instances. In some embodiments, UE may report two LIs/CQIs corresponding to the first and last CMR instances respectively. The CMR instance may be actual CMR instance or virtual CMR instance.

In another implementation, UE may measure and report the LI/CQI based on averaging precoder and channel among multiple CMR instance. The CMR instances for LI/CQI selection may be the same as that used for precoder calculation. In some embodiments, the CMR instances for LI/CQI selection may be configured by RRC signaling, e.g., RRC parameters in CSI-ReportConfig, or MAC CE, or DCI.

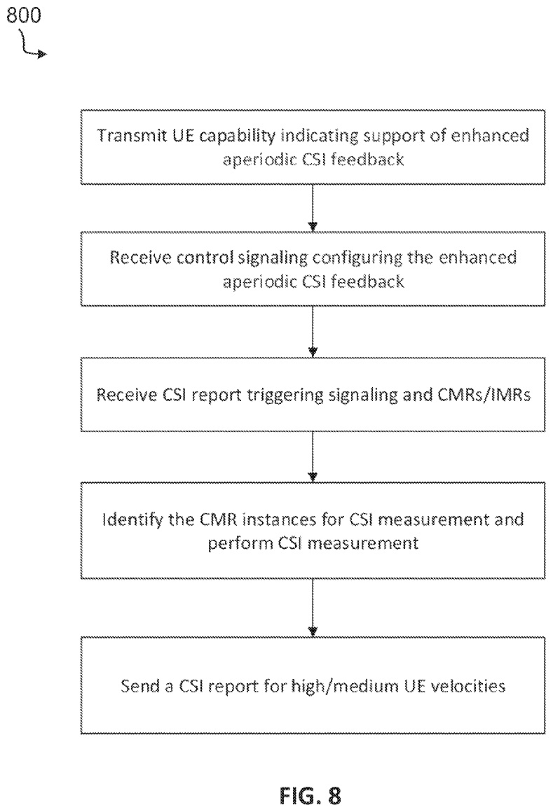

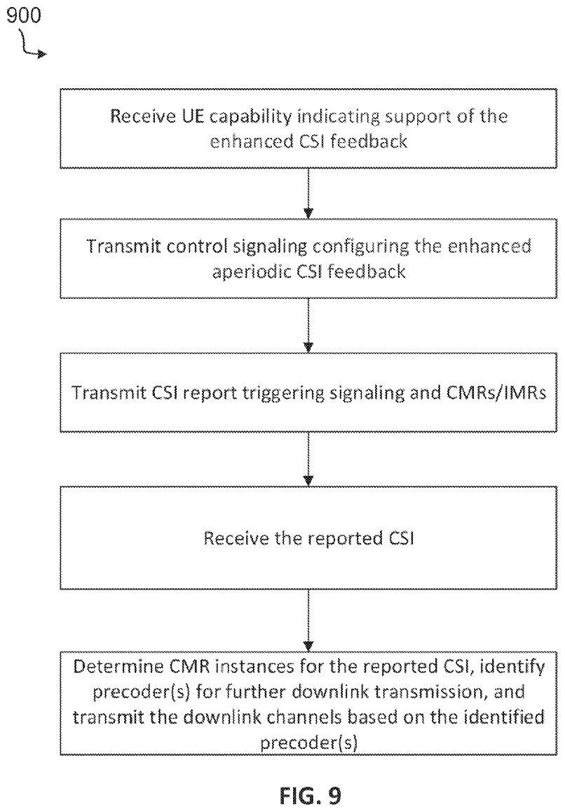

FIG. 8 is a flow diagram depicting a method 800 of wireless communications by a user equipment (UE) device, according to some embodiments. FIG. 9 is a flow diagram depicting a method 900 of wireless communications by a network entity complementary to the method 800, according to some embodiments. In some implementations, the gNB determines whether to configure the enhanced aperiodic CSI feedback for a UE, based on whether receiving the one or more capabilities indicating support of the enhanced aperiodic CSI feedback. If the gNB receives the one or more capabilities of the UE, indicating support of the enhanced aperiodic CSI feedback, the gNB transmits the control signaling (e.g., a RRC message such as an RRCReconfiguration message or RRCResume message) to the UE to configure the enhanced aperiodic CSI feedback. Otherwise, if the gNB determines that the UE does not support the enhanced aperiodic CSI feedback, the gNB refrains from configuring the enhanced aperiodic CSI feedback for the UE. That is, the gNB refrains from transmitting control signaling configuring the enhanced aperiodic CSI feedback to the UE. In this case, the gNB can transmit control signaling (e.g., a RRC message such as an RRCReconfiguration message or RRCResume message) configuring the legacy aperiodic CSI feedback to the UE. After configuring the legacy aperiodic CSI feedback for the UE, the gNB can transmit CSI report triggering signaling (e.g., a MAC CE or DCI) to the UE to trigger the legacy aperiodic CSI feedback.

In some further implementations, if the gNB determines that the UE supports the enhanced aperiodic CSI feedback based on the one or more capabilities indicating support of the enhanced aperiodic CSI feedback, the gNB can determine whether to configure the enhanced aperiodic CSI feedback for the UE based on a mobility state of the UE. The gNB communicates with the UE operating in a connected state (e.g., RRC_CONNECTED state). If the gNB determines that the UE is a high or medium mobility state, the gNB transmits the control signaling (e.g., a RRC message such as an RRCReconfiguration message or RRCResume message) to the UE to configure the enhanced aperiodic CSI feedback for the UE. Otherwise, if the gNB determines that the UE is in a low mobility state, the gNB refrains from configuring the enhanced aperiodic CSI feedback for the UE. That is, the gNB refrains from transmitting control signaling configuring the enhanced aperiodic CSI feedback to the UE. In some implementations, if the gNB determines that the UE is in a low mobility state, the gNB can transmit control signaling (e.g., a RRC message such as an RRCReconfiguration message or RRCResume message) configuring the legacy aperiodic CSI feedback to the UE.

In some embodiments, the gNB can transmit control signaling (e.g., a RRC message such as an RRCReconfiguration message or RRCResume message) configuring the legacy aperiodic CSI feedback to the UE, irrespective of a mobility state of the UE. After configuring the legacy CSI feedback for the UE, the gNB can transmit CSI report triggering signal to the UE to trigger the legacy aperiodic CSI feedback.

In other implementations, the gNB determines to configure the enhanced aperiodic CSI feedback for the UE based on the one or more capabilities indicating support of the enhanced aperiodic CSI feedback, irrespective of a mobility state of the UE, as described above. The gNB communicates with the UE operating in a connected state (e.g., RRC_CONNECTED state). If the gNB determines that the UE is a high or medium mobility state, the gNB transmits the CSI report triggering signaling and CMRs/IMRs to the UE. Otherwise, if the gNB determines that the UE is in a low mobility state, the gNB refrains from transmitting the CSI report triggering signaling and CMRs/IMRs to the UE. In some implementations, the gNB can configure the legacy aperiodic CSI feedback for the UE as described above. After configuring the legacy CSI feedback for the UE, the gNB can transmit CSI report triggering signal to the UE to trigger the legacy aperiodic CSI feedback.

In some implementations, the gNB can determine a mobility state of the UE based on sounding reference signal received from the UE. In other implementations, the gNB can determine a mobility state of the UE based on Doppler effect (e.g., Doppler shift and/or Doppler spread) report received from the UE. In yet other implementations the gNB can determine a mobility state of the UE based on a mobility state report received from the UE. For example, the gNB can transmit a message to the UE to configure the UE report a mobility state. In one implementation, the message can be an RRCReconfiguration message, a RRCResume message or a MAC CE. In response to the message, the UE transmits a mobility state report including a mobility state of the UE to the gNB. In one implementation, the mobility state report can be a RRC message (e.g., UEAssistanceInformation message) or a MAC CE. In some implementations, the mobility state report can include a mobility state (e.g., high, medium or low) and/or a velocity. In some implementations, the gNB can include one or more thresholds in the message. The UE uses the one or more thresholds to determine a mobility state (e.g., high, medium or low).

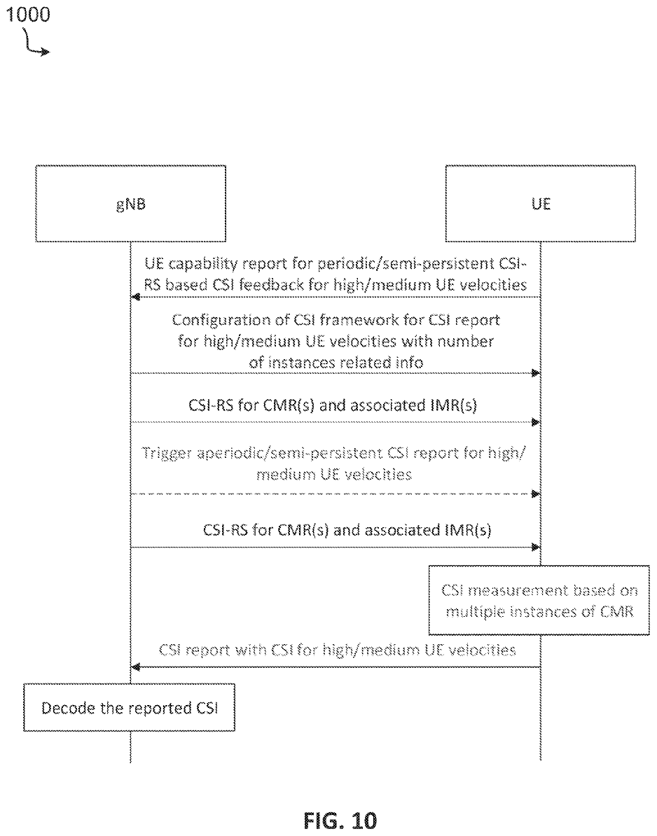

FIG. 10 illustrates an example call flow diagram 1000 of enhancing aperiodic and semi-persistent CSI feedback to support a UE device with high/medium velocity, according to some embodiments. For example, the call flow diagram shows the general procedure for CSI feedback for high/medium UE velocities based on periodic/semi-persistent CSI-RS. Compared to the procedure in FIG. 6, the difference is as follows.

In UE capability report, UE may report whether it support CSI feedback for high/medium UE velocities based on periodic/semi-persistent CSI-RS, as well as maximum number of periodic/semi-persistent CSI-RS resources, maximum number of instances, maximum number of CSI report configuration for periodic/semi-persistent CSI, and/or maximum number of periodic/semi-persistent CSI report.

In the control signaling for CSI framework for CSI report, gNB may only need to configure the number of instances (N4) and/or CSI report scheme. The interval between two consecutive instances can be derived based on the periodicity for the periodic/semi-persistent CSI-RS.

Some or all the instances for CSI-RS configured as CMR can be transmitted before the control signaling to trigger the CSI report.

The signaling to trigger semi-persistent CSI report can be a MAC CE. In some implementation, the number of instances (N4) may be indicated by the MAC CE.

In this disclosure, unless specified, a RRC signaling may indicate a RRC reconfiguration message from gNB to UE, or a system information block (SIB), where the SIB can be an existing SIB (e.g., SIB1) or a new SIB transmitted by gNB. In addition, the gNB may obtain the UE capability via UE capability report signaling or from a core network (e.g., Access and Mobility Management Function (AMF)).

Further in this disclosure, solutions described are based on 5G NR technologies. It should be understood that the solutions can be applied to other wireless technologies such as 6G. The “gNB” can be generalized as a base station or a radio access network (RAN) node.

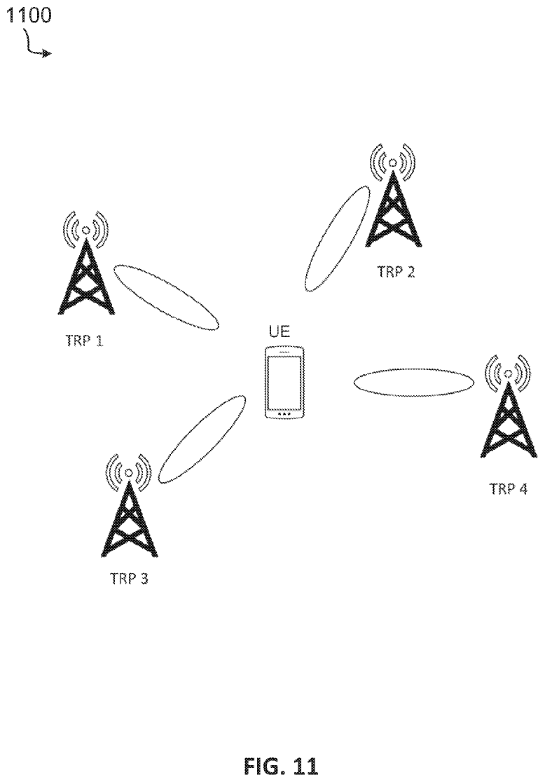

FIG. 11 is an example 1100 depicting coherent joint transmission (CJT), according to some embodiments. As shown, the UE may receive downlink signal from up to N_{TRP}, e.g., N_{TRP}=4, transmission and reception points (TRPs) based on coherent transmission operation. For CJT, cross-TRP antenna combining could be applied. In one example, the precoder for a PDSCH transmission layer could be generated as [α₁P₁ α₂P₂ α₃P₃ α₄P₄]^{T}, where αₖ indicates the antenna combining factor for TRP k, and indicates the Pₖ precoder for TRP k.

Since Rel-15, the Type 2 CSI codebook for CSI report for a TRP is introduced for the UE to measure and report the CSI, where a precoder is quantized as follows:

$$W = {W}_{1} {W}_{2}$$

Where W₁ is a wideband precoder with the dimension of N_{Tx} by 2L; W₂ is a subband precoder with the dimension of 2L by ν; L indicates the number of beams, and ν indicates the number of layers, which is RI+1.

W₁ can be quantized based on a codebook, while W₂ could be quantized based on power and angle for each element, which could lead to a large overhead since W₂ is subband based, and there could be multiple subbands for a CSI report, which is determined by the bandwidth for the CSI-RS. In one example, the codebook for W1 selection can be defined as follows:

$${W}_{1} = [ \begin{matrix}B & 0 \\ 0 & B\end{matrix} ]$$

$$B = [ \begin{matrix}{b}_{1} & {b}_{2} & … & {b}_{L}\end{matrix} ]$$

$${b}_{l} = {u}_{m} ⊗ {v}_{n}$$

$${u}_{m} = {[ \begin{matrix}1 & {e}^{\frac{j 2 π m}{{N}_{1} {O}_{1}}} & … & {e}^{\frac{j 2 π ( {N}_{1} - 1 ) m}{{N}_{1} {O}_{1}}}\end{matrix} ]}^{T}$$

$${v}_{n} = {[ \begin{matrix}1 & {e}^{\frac{j 2 π n}{{N}_{2} {O}_{2}}} & … & {e}^{\frac{j 2 π ( {N}_{2} - 1 ) n}{{N}_{2} {O}_{2}}}\end{matrix} ]}^{T}$$

Where, ⊗ denotes Kronecker product; L indicates number of beams which are configured by RRC signaling; N₁, N₂, O₁, and O₂ are related to the number of ports and oversampling factor in horizontal and vertical domain, which are configured by RRC signaling, and the candidate values should be determined based on number of CSI-RS ports. The codebook contains the precoders with different value of m and n. In one example, candidate values are defined as Table 5.2.2.2.1-2 in 3GPP specification 38.214.

In Rel-16, an enhanced Type2 codebook for a CSI report for a TRP is introduced, where the precoder can be quantized as follows:

$$W = {W}_{1} {\overline{W}}_{2} {W}_{f}^{H}$$

Where, \tilde{W}₂ indicates a wideband beam combining weight with the dimension of 2L by M, and W_{f} indicates a frequency domain basis with the dimension of N₃ by M, where N₃ is the number of subbands and can be derived by RRC parameter numberOfPMI-SubbandsPerCQI-Subband, and M can be derived by RRC signaling numberOfPMI-SubbandsPerCQI-Subband and paramCombination. Details can be found at section 5.2.2.2.5 in 3GPP specification 38.214.

One possible way to perform CSI feedback for CJT could be to report a quantized CSI as [(α₁W¹)^{T} (α₂W²)^{T} (α₃W³)^{T} (α₄W⁴)^{T}], where W^{k} indicates the quantized precoder for TRP k. In some embodiments, another possible way is to extend current codebook for a multi-TRP operation, by considering the beams from multiple TRPs. So that the dimension for each weight can be defined as W₁ is a wideband precoder with the dimension of N_{TRP}*N_{Tx} by N_{TRP}*2L, \tilde{W}₂ indicates a wideband beam combining weight with the dimension of N_{TRP}*2L by M.

Regardless of which quantization scheme is used, how to configure the CSI framework to support CSI feedback for CJT could be one problem, e.g., CMR/IMR configuration and association, CSI-RS configuration, as well as UE behavior for the CMR/IMR measurement and CSI-RS reception. The CSI framework should also support TRP selection. A second problem could be how to define a UE behavior for CJT CSI measurement, e.g., the CPU occupancy rule and minimal processing delay for CJT CSI measurement and report.

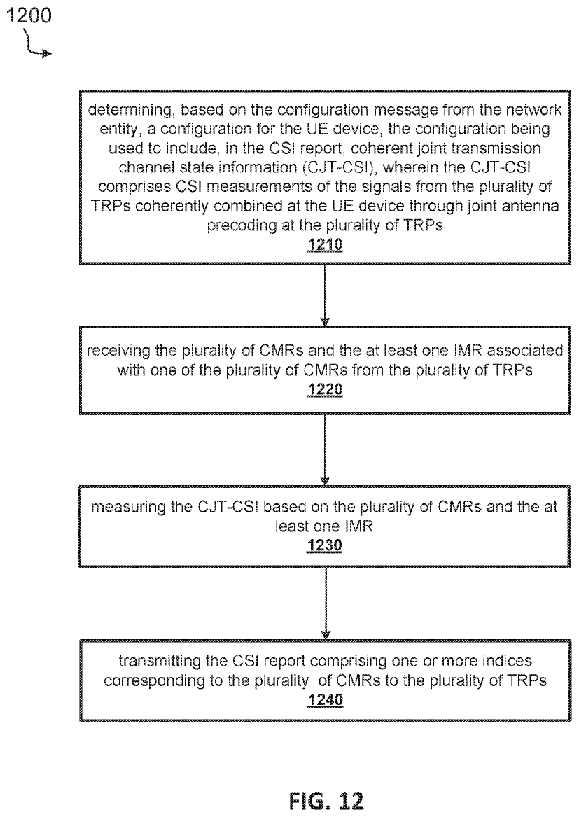

FIG. 12 is a flow diagram 1200 depicting a method of CJT CSI reporting by a user equipment (UE) device, according to some embodiments. The method is performed by processing logic that includes hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. The method of the flow diagram 1200 is performed by a UE device. The network entity may include one or more radio frequency (RF) modems, a processor coupled to the one or more RF modems, and at least one non-transient memory storing executable instructions to manipulate at least one of the processor or the RF modems to perform the method of the flow diagram 1200. A network entity may perform a complimentary method to interact with the UE device performing the method 1200 (see call flow diagram in FIG. 3).

With reference to FIG. 12, method illustrates example functions used by various embodiments. Although specific function blocks (“blocks”) are disclosed in method, such blocks are examples. That is, embodiments are well suited to performing various other blocks or variations of the blocks recited in method. It is appreciated that the blocks in method may be performed in an order different than presented, and that not all of the blocks in method may be performed.

As shown in FIG. 12, the method 1200 includes the block 1210 of determining, based on the configuration message from the network entity, a configuration for the UE device, the configuration being used to include, in the CSI report, coherent joint transmission channel state information (CJT-CSI), wherein the CJT-CSI includes CSI measurements of the signals from the multiple TRPs coherently combined at the UE device through joint antenna precoding at the multiple TRPs.

The method 1200 includes the block 1220 of receiving the multiple CMRs and the at least one IMR associated with one of the multiple CMRs from the multiple TRPs.

The method 1200 includes the block 1230 of measuring the CJT-CSI based on the multiple CMRs and the at least one IMR.

The method 1200 includes the block 1240 of transmitting the CSI report including one or more indices corresponding to the multiple CMRs to the multiple TRPs.

In some embodiments, the configuration message includes at least one of: a radio resource control (RRC) reconfiguration message; or a system information block (SIB).

In some embodiments, the indication of the capability of reporting the CSI report includes, for each component carrier (CC), each bandwidth part (BWP), each band, each band configuration, or each UE device in a group of UE devices including the UE device, any of: a maximum number of TRPs that the UE device supports for the CSI report of the CJT-CSI; a maximum number of CMRs per the configuration message for the CJT-CSI; a maximum number of antenna ports per each of the multiple CMRs; a maximum number of a total number of antenna ports across the multiple CMRs for the CSI report; a maximum number of CMRs across multiple configuration messages (of CSI-reportConfig); and a maximum number of the multiple configuration messages.

In some embodiments, the multiple CMRs includes one or more groups of CMRs across the multiple TRPs, the one or more groups of CMRs is configured by the configuration message, and the CSI report includes an index identifying one of the one or more groups of CMRs.

In some embodiments, the CSI report further includes at least one of: a rank indicator (RI); a precoder matrix indicator (PMI); a channel quality indicator (CQI); a layer indicator; or one or more CSI-RS resource indicators (CRIs).

In some embodiments, the UE device may perform concurrent measurements by: measuring the CJT-CSI when a CSI processing unit (CPU) at the UE device is available for processing the multiple CMRs, wherein the CPU at the UE device is configured based on a total number of the one or more groups of CMRs. For example, the UE device may determine that a trigger to include CJT-CSI in the CSI report requires a quantity of CPUs that exceeds a maximum number of CPUs included in the indication of the capability of reporting a CSI report; and discard the trigger or determining that the trigger corresponds to an erroneous request from the network entity.

In some embodiments, the UE device may run multiple CPUs to perform multiple CJT-CST measurements in parallel for inclusion in the CSI report; wherein a quantity of the multiple CPUs imposes a maximum number of CJT-CSI measurements that the UE device is capable of performing in parallel.

In some embodiments, the at least one IMR includes one or more of a zero-power IMRs (ZP-IMRs) and non-zero-power IMRs (NZP-IMRs), and wherein the at least one IMR is associated with one of the one or more groups of CMRs.

The method 1200 may further include: measuring the at least one IMR with multiple reception beams at the UE device; or measuring the at least one IMR across two or more CMRs in the one of the one or more groups of CMRs.

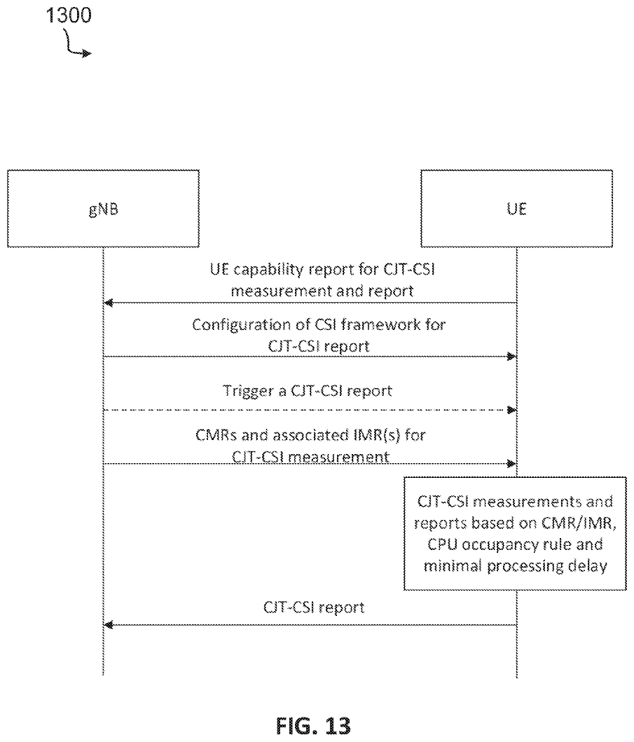

FIG. 13 illustrates an example call flow diagram 1300 of CJT CSI reporting, according to some embodiments. As shown, the call flow diagram 1300 illustrates the general procedure for CJT based CSI (CJT-CSI) report. The UE may perform CJT-CSI measurements and reports based on one, some or all of the following capabilities for CJT-CSI measurements and/or reports:
the maximum number of TRPs that the UE can support for CJT-CSI report(s)
the maximum number of CJI-CSI report(s) for which the UE can measure and process reference signals simultaneously, for which this capability is provided.
the minimal processing delay for CJT-CSI measurements and reports

In some implementations, each, some or all of the capabilities can be defined or specified per CC per band combination supported by the UE. Each, some or all of the one or more capabilities for each of CCs in a band combination supported by the UE can be the same or different. Each, some or all of the capabilities for CCs in different band combinations supported by the UE can be the same or different.

In other implementations, each, some or all of the capabilities can be defined or specified per band combination supported by the UE. Each, some or all of the capabilities for different band combinations supported by the UE can be the same or different. In some implementations, a band combination can be an intra-band contiguous band combination, an intra-band non-contiguous band combination or inter-band band combination.

In yet other implementations, each, some or all of the capabilities can be defined or specified per band supported by the UE. (Each or some of) the capabilities for bands supported by the UE can be the same or different.

In yet other implementations, each, some or all of the capabilities can be defined or specified per frequency range (FR) supported by the UE. Each, some or all of the one or more capabilities for FRs (e.g., FR1 and FR2) supported by the UE can be the same or different.

In yet other implementations, each, some or all of the capabilities can defined or specified per UE, i.e., irrespective of CCs, band combinations, bands and FRs.

In some implementations, the UE can transmit one, some or all of the capabilities to the gNB. In one implementation, the UE transmits a UE capability information message (e.g., UECapabilityInformation message) including multiple UE capabilities of the UE (e.g., UE-NR-Capability IE), which include the one, some or all of the capabilities to a gNB. The gNB can transmit the multiple UE capabilities to a core network (CN) (e.g., access and mobility function (AMF)) and the CN stores the multiple UE capabilities for the UE. In another implementation, the UE uses a capability ID identify the multiple UE capabilities that has been pre-stored in the CN. The UE transmits a non-access-stratum (NAS) message including the capability ID to the CN via a gNB. With either one of the implementations above, next time when the UE connects to a gNB, the gNB can receive the multiple UE capabilities from the CN without requesting the UE to transmit the multiple UE capabilities. In other implementations, one, some or all of the capabilities for CJT-CSI measurements and/or reports can be pre-defined in a 3GPP specification without the UE transmit the capability/capabilities to a gNB or CN.

Based on the capability/capabilities for CJT-CSI measurements and/or reports, the gNB can configure the UE to perform CJT-CSI measurements and reports. In some implementations, the gNB transmits to the UE a RRC message (e.g., RRCReconfiguration message or RRCResume message) including CSI-reportConfig IE(s) where each can configure CMRs, at least one IMR to be associated with each of the CMRs for CJT-CSI measurement, and a configuration of an uplink resource, e.g., PUCCH or PUSCH, for CJT-CSI report. In some implementations, the gNB may configure multiple CMR groups as well as the IMR(s) associated with each CMR group for CJT-CSI measurement in the RRC message. In one implementation, each of the CMR groups includes or configures multiple CMRs where each can be associated with one or more IMRs. Based on the CMR group(s), the UE determines the CMRs in (each of) the CMR group(s) for CJT-CSI measurement. Accordingly, the UE performs CJT-CSI measurements based on the CMRs or CMR group(s) and associated IMR(s) (if configured). In some implementations, the gNB can include a CMR group index for each of the CMR group(s) in the RRC message. In other implementations, the gNB does not include a CMR group index in the RRC message. In such cases, the UE can determine a CMR group index for each of the CMR group(s) based on an order of the each CMR group in a container (e.g., a list IE such as an addition and/or modification list IE) including the CMR group(s).

In some implementations, the gNB may trigger CJT-CSI reporting by transmitting a triggering message (e.g., a MAC CE or DCI) to the UE. In response to the triggering message, the UE transmits one or more CJT-CSI reports on the uplink resource to the gNB. In one example, the gNB may trigger semi-persistent CJT-CSI reporting by transmitting a MAC CE to the UE. The gNB can stop or deactivate the semi-persistent CJT-CSI reporting by transmitting a deactivation command (e.g., MAC CE) to the UE In another example, the gNB may trigger an aperiodic CJT-CSI report by transmitting a DCI to the UE. In some implementations, the UE may perform CJT-CSI measurements based on CMRs/IMRs configured in the CSI-reportConfig IE(s) for periodic CJT-CSI reporting. In some implementations, the UE may perform CJT-CSI measurements based on CMRs/IMRs configured in the CSI-reportConfig IE(s) for semi-persistent or aperiodic CJT-CSI reporting, upon receiving the triggering message. The UE may stop performing CJT-CSI measurements based on CMRs/IMRs configured in the CSI-reportConfig IE(s) for semi-persistent CJT-CSI reporting, upon receiving the deactivation command.

In some implementations, the UE has multiple CSI processing units (CPUs) dedicated to the CJT-CSI measurements and/or reporting. In one implementation, the number of the multiple CPUs determines the maximum number of CJI-CSI report(s) for which the UE can measure and process reference signals simultaneously, for which this capability is provided. While performing the CJT-CSI measurements and/or reporting, the UE determines a CSI processing unit (CPU) occupancy for each of the CPUs.

In other implementations, the UE has multiple CSI processing units (CPUs) that the UE can use to perform the CJT-CSI measurements and/or reporting and as well as other type(s) of CSI measurement and/or reporting (e.g., non-CJT-CSI measurements and/or reporting). While performing the CJT-CSI measurements and/or reporting and other type(s) of CSI measurement and/or reporting, the UE determines a CSI processing unit (CPU) occupancy for each of the CPUs. In one implementation, if the UE has been using a CPU for a non-CJT-CSI measurement and/or reporting, the UE cannot use the CPU to perform a CJT-CSI measurement and/or reporting. Similarly, if the UE has been using a CPU for a CJT-CSI measurement and/or reporting, the UE cannot use the CPU to perform a non-CJT-CSI measurement and/or reporting.

In some implementations, the UE may measure and report the CJT-CSI report(s) based on the CMRs and associated IMR(s), CPU occupancy rule and minimal processing delay for the CSI triggered by other CSI-reportConfig and CJT-CSI. In some implementations, in a CJT-CSI report, UE may report a CMR group index or multiple CSI-RS resource index(es) (CRIs) as well as the corresponding CSI, e.g., RI/PMI/CQI/LI. The CMR group index identifies or indicates a particular CMR group of the configured CMR group(s) and the UE obtains the CSI from CMRs and associated IMR(s) (if configured) in the particular CMR group. The CRIs identifies or indicates particular CMRs and associated IMR(s) (if configured) from which the UE obtains the CSI.

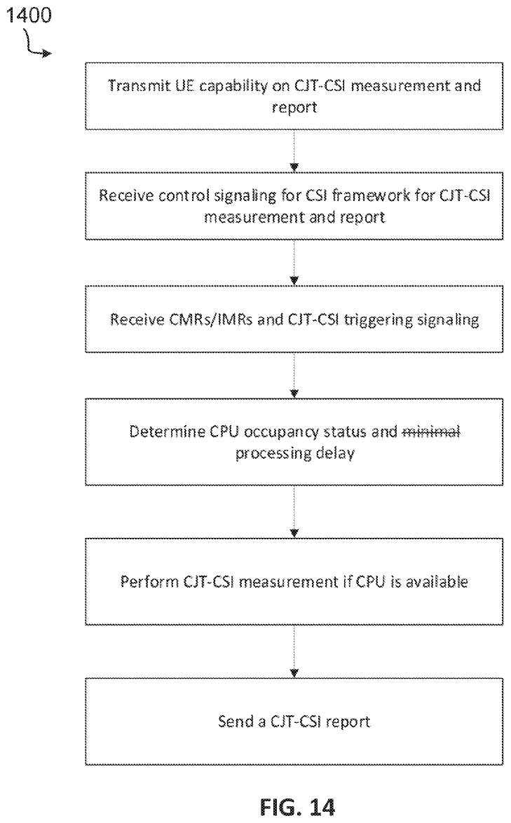

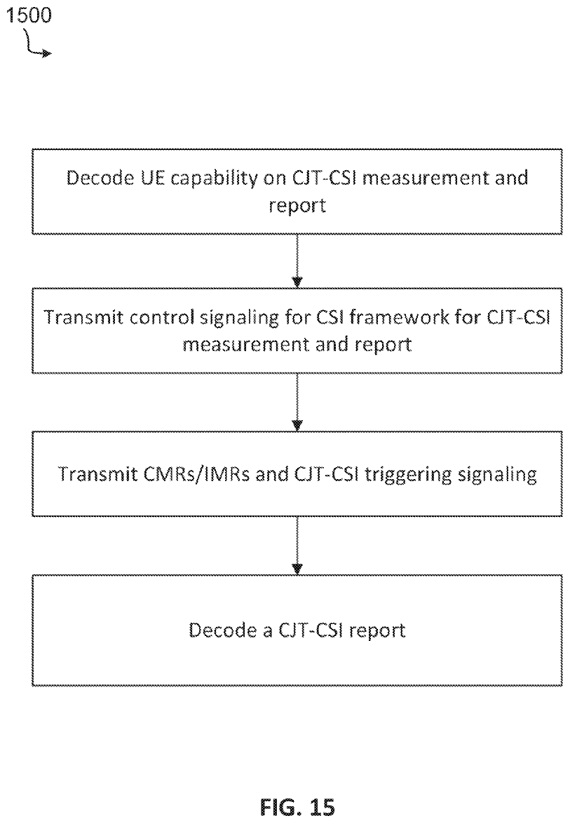

FIG. 14 is a flow diagram depicting a method 1400 of CJT CSI reporting by a user equipment (UE) device, according to some embodiments. FIG. 15 is a flow diagram depicting a method 1500 of CJT CSI reporting by a network entity, according to some embodiments. According to aspects of the present disclosure, unless specified, a RRC signaling may include a RRC reconfiguration message from gNB to UE, or a system information block (SIB), where the SIB can be an existing SIB (e.g., SIB1) or a new SIB (e.g., SIB J, J>21) transmitted by gNB. In addition, the gNB may obtain the UE capability via UE capability report signaling or from a core network (e.g., Access and Mobility Management Function (AMF)).

Further in this disclosure, solutions described are based on 5G NR technologies. It should be understood that the solutions can be applied to other wireless technologies such as 6G. The “gNB” can be generalized as a base station or a radio access network (RAN) node.

In an embodiment, the UE may report its capability on the maximum number of TRPs it can support for CJT-CSI report, maximum number of CMRs per CSI-reportConfig for CJT-CSI report, maximum number of antenna ports per CMR for CJT-CSI report, maximum number of total antenna ports across CMRs for a CJT-CSI report, maximum number of CMRs across CSI-reportConfig for CJT-CSI report, and/or maximum number of CSI-reportConfig for CJT-CSI report. These numbers may be counted per component carrier (CC), per bandwidth part (BWP), per band, per band combination and/or per UE.

In an embodiment, for CMR configuration for CJT-CSI measurement, the gNB can configure N CMR groups for CSI reporting by RRC signaling, e.g., in a CSI-reportConfig that the gNB transmits to the UE, where N should be an integer above 0. Within a CMR group k, the gNB may configure N_{TRP,k} CMRs, where N_{TRP,k} should be an integer above 1. Each CMR within a CMR group corresponds to one TRP. In a CSI report, the UE may report a CMR group index, as well as corresponding RI/PMI/CQI/LI measured from the CMRs. In one implementation, for UE reporting a CMR group index k, the CSI should be measured from all the CMRs within the CMR group. In another implementation, for UE reporting a CMR group index k, UE may report an indicator to report index(es) of measured CMR within the CMR group to report from which CMR(s) in the CMR group, the CSI is measured. In one implementation, if gNB only activates or configures 1 CMR group for CSI report, UE does not report the CMR group index.

In one implementation, for IMR configuration, the gNB may configure one ZP IMR and/or one NZP IMR associated with each CMR group by RRC signaling, e.g., RRC parameters in a CSI-reportConfig, where the CMR/IMR(s) are associated in an N-to-one manner. UE can measure interference based on the configured IMR(s) and channel based on the CMRs configured with the CMR group. For such N-to-one CMR/IMR association operation, for a UE with multiple beams, e.g., UE that supports quasi-co-location (QCL) typed (QCL with spatial Rx parameters), or in frequency range 2, the UE may receive the IMR based on multiple QCL-TypeD assumptions based on all the CMRs in a CMR group. In one example, if UE receives the CMRs in a CMR group based on UE beam #1, #2 and #3, the UE receives the IMRs based on beam #1, #2, #3. The interference may be measured based on the average/maximum/minimal/total interference measured from the UE beams (UE antenna ports).

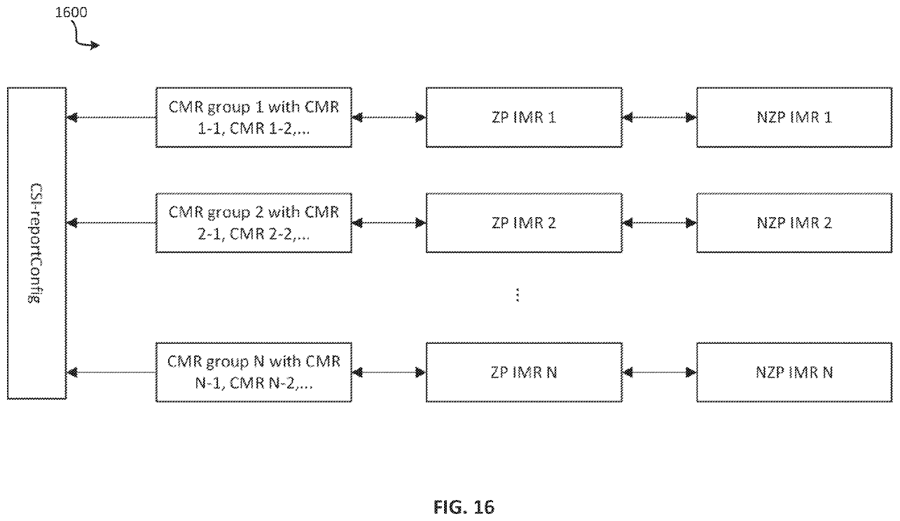

FIG. 16 illustrates an example 1600 for CSI framework for CMR/IMR configuration and association for CJT-CSI report, according to some embodiments. The example 1600 illustrates one example for the CSI framework for this implementation. In one example, in CSI-ResourceConfig configured as CMR for semi-persistent/periodic CJT-CSI report, the gNB can configure up to N resource sets in nzp-CSI-RS-Resource SetList with N_{TRP,k} resource(s) for resource set k, and in CSI-ResourceConfig configured as IMR for semi-persistent/periodic CJT-CSI report, the gNB can configure one resource set in nzp-CSI-RS-Resource SetList or csi-IM-ResourceSetList with N resources. In another example, for aperiodic CJT-CSI report, the gNB can configure up to N resource Set in CSI-AssociatedReportConfigInfo for gNB to select N CMR groups.

The gNB can indicate the associated IMRs by indicating N csi-IM-ResourcesForInterference and nzp-CSI-RS-ResourcesForInterference in CSI-AssociatedReportConfigInfo, where each resource set for IMR includes one IMR. In some embodiments, the gNB can indicate the associated IMRs by indicating one csi-IM-ResourcesForInterference and one nzp-CSI-RS-ResourcesForInterference in CSI-AssociatedReportConfigInfo, where each resource set for IMR includes N IMRs. In some embodiments, for aperiodic CJT-CSI reports, the gNB triggers all the configured CMR set(s) and/or all the configured IMR set(s) for the triggered CSI-ReportConfig, e.g., the UE ignores the RRC parameter resourceSet, nzp-CSI-RS-ResourceSetList or csi-IM-ResourceSetList, or the gNB refrains from configuring resource Set, nzp-CSI-RS-ResourceSetList or csi-IM-ResourceSetList. The gNB transmits one or more RRC messages (e.g., RRCReconfiguration message or RRCResume message) including these configurations to the UE.

In another implementation, for IMR configuration, the gNB may configure N_{TRP,k} ZP IMR and/or N_{TRP,k} NZP IMR associated with CMRs in a CMR group by RRC signaling, e.g., RRC parameters in a CSI-reportConfig, where the CMR/IMR(s) are associated in a one-to-one manner. For such one-to-one CMR/IMR association operation, UE can measure interference based on the minimal/average/maximum/total interference measured from the configured IMR(s) for the CMR group. For interference measurement from NZP-IMR, the gNB may configure the antenna combining factor for each NZP-IMR resource associated with CMRs in the CMR group. In one implementation, the measured interference from a subcarrier u for NZP-IMRs for CMR group k can be calculated as

$${\vert {\sum }_{j = 1}^{{N}_{TRP , k}} {ρ}_{j} {\hat{H}}_{u , j} \vert}^{2} ,$$

where ρⱼ indicates the antenna combing factor configured by gNB for NZP IMR resource j, Ĥ_{u,j} indicates the estimated effective channel for subcarrier u from NZP-IMR j. In some embodiments, the antenna combining factor for NZP-IMR may be predefined.

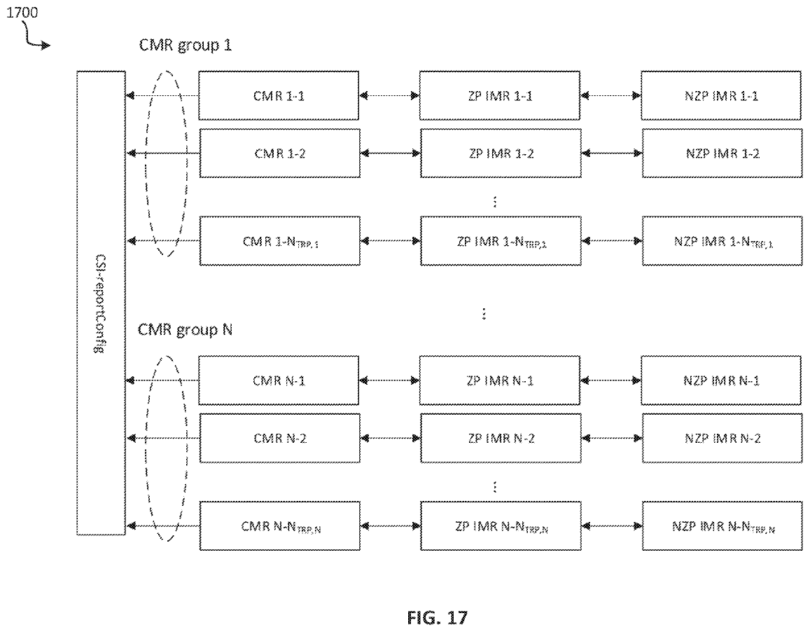

FIG. 17 illustrates an example 1700 for CSI framework for CMR/IMR configuration and association for CJT-CSI report, according to some embodiments. The example 1700 illustrates one example for the CSI framework for this implementation. In one example, in CSI-ResourceConfig configured as CMR/IMR for semi-persistent/periodic CJT-CSI report, the gNB can configure N resource sets in nzp-CSI-RS-ResourceSetList or csi-IM-ResourceSetList with N_{TRP,k} resource(s) for resource set k. In another example, for aperiodic CJT-CSI report, the gNB can configure up to N resourceSet, csi-IM-ResourcesForInterference, nzp-CSI-RS-ResourcesForInterference and in CSI-AssociatedReportConfigInfo for gNB to select N CMR groups as well as corresponding ZP-IMRs and NZP-IMRs. In another example, for aperiodic CJT-CSI report, the gNB can configure up to N resourceSet in CSI-AssociatedReportConfigInfo for gNB to select N CMR groups, and the associated ZP-IMRs/NZP-IMRs. In some embodiments, for aperiodic CJT-CSI reports, the gNB triggers all the configured CMR set(s) and/or all the configured IMR set(s) for the triggered CSI-ReportConfig, e.g., the UE ignores the RRC parameter resourceSet, nzp-CSI-RS-ResourceSetList or csi-IM-ResourceSetList, or the gNB refrains from configuring resourceSet, nzp-CSI-RS-ResourceSetList or csi-IM-ResourceSetList. The gNB transmits one or more RRC messages (e.g., RRCReconfiguration message or RRCResume message) including these configurations to the UE.

In another implementation, for IMR configuration, the gNB may configure one ZP IMR and/or N_{TRP,k} NZP IMR associated with CMRs in a CMR group by RRC signaling, e.g., RRC parameters in a CSI-reportConfig, where the CMR and NZP-IMR are one-to-one associated. The UE behavior for interference measurement over the ZP/NZP IMR is based on the implementations above for N-to-one CMR/IMR association and one-to-one IMR/CMR association respectively.

In another implementation, for IMR configuration, the gNB may configure one NZP IMR and/or N_{TRP,k} ZP IMR associated with CMRs in a CMR group by RRC signaling, e.g., RRC parameters in a CSI-reportConfig, where the CMR and ZP-IMR are one-to-one associated. The UE behavior for interference measurement over the NZP/ZP IMR is based on the implementations above for N-to-one CMR/IMR association and one-to-one IMR/CMR association respectively.

In another embodiment, for CMR configuration for CJT-CSI measurement, the gNB can configure N_{TRP} CMR groups for a CSI report by RRC signaling, e.g., in a CSI-reportConfig, where N_{TRP} should be an integer above 1. Within a CMR group k, the gNB may configure Mₖ CMRs, where Mₖ should be an integer above 0. Each CMR group corresponds to one TRP. In a CSI report, the UE may report a 1 or more than 1 CRIs, as well as corresponding RI/PMI/CQI/LI measured from the CMRs, where reporting 1 CRI indicates the CSI is measured from a single TRP and reporting more than 1 CRIs indicate the CSI is measured from multiple TRPs. In one implementation, the CRI may be counted across the CMR groups. In another implementation, the CRI may be counted within a CMR group, and then UE may report a CMR group index in addition to each reported CRI. The number of reported CRIs associated with RI/PMI/CQI/LI may be predefined, e.g., based on the number of CMR groups, or configured by RRC signaling in CSI-reportConfig or MAC CE by gNB, or reported by UE in a CSI report. In one example, the UE may report the selected CMR group index(es) in a CSI report. Then the number of reported CRIs should be the same as the number of selected CMR group index(es). For CSI reported in long PUCCH or PUSCH, the selected CMR group index(es) may be reported in CSI part 1. Then the CSI reported in CSI part 2 should be reported based on the reported CMR group index(es) in CSI part 1.

In an implementation, for IMR configuration, the gNB may configure Mx ZP IMR and/or Mx NZP IMR associated with CMRs in a CMR group by RRC signaling, e.g., RRC parameters in a CSI-reportConfig, where the CMR/IMR(s) are associated in a one-to-one manner. For such one-to-one CMR/IMR association operation, UE can measure interference based on the minimal/average/maximum/total interference measured from the configured IMR(s) associated with the CMR(s) indicated by the reported CRI(s). For interference measurement from NZP-IMR, the gNB may configure the antenna combining factor for each NZP-IMR resource associated with CMRs in the CMR group. In one implementation, the measured interference from a subcarrier u for NZP-IMRs for CMR group k can be calculated as

$${\vert {\sum }_{j = 1}^{{N}_{TRP , k}} {ρ}_{j} {\hat{H}}_{u , j} \vert}^{2} ,$$

where ρⱼ indicates the antenna combing factor configured by gNB for NZP IMR resource j, Ĥ_{u,j} indicates the estimated effective channel for subcarrier u from NZP-IMR j. In some embodiments, the antenna combining factor for NZP-IMR may be predefined.

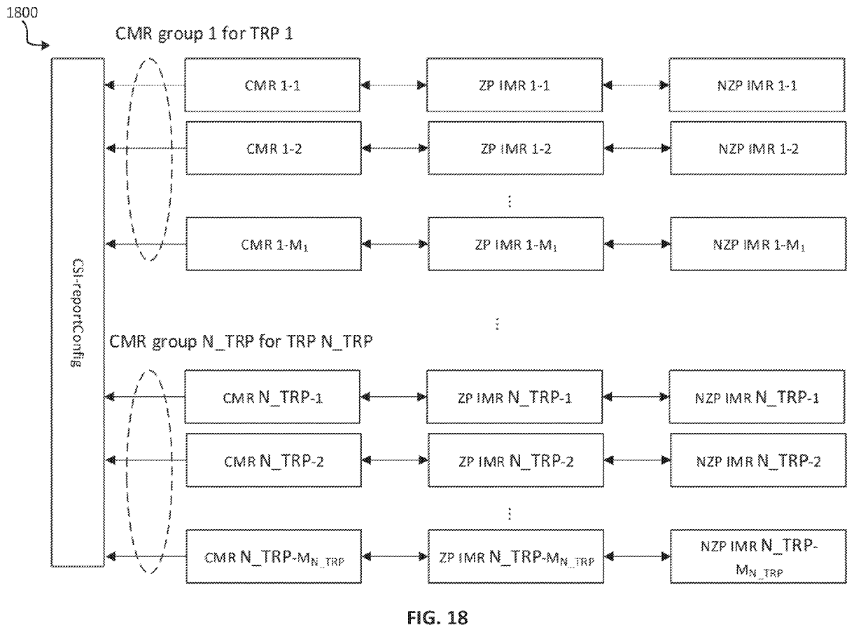

FIG. 18 illustrates an example 1800 for CSI framework for CMR/IMR configuration and association for CJT-CSI report, according to some embodiments. The example 1800 illustrates one example for the CSI framework for this implementation. In one example, in CSI-ResourceConfig configured as CMR/IMR for semi-persistent/periodic CJT-CSI report, the gNB can configure N_{TRP} resource sets in nzp-CSI-RS-ResourceSetList or csi-IM-ResourceSetList with Mₖ resource(s) for resource set k. In another example, for aperiodic CJT-CSI report, the gNB can configure up to N_{TRP} resourceSet, csi-IM-ResourcesForInterference and nzp-CSI-RS-ResourcesForInterference in CSI-AssociatedReportConfigInfo for gNB to select N_{TRP} CMR groups as well as corresponding ZP-IMRs and NZP-IMRs. In some embodiments, for aperiodic CJT-CSI reports, the gNB triggers all the configured CMR set(s) and/or all the configured IMR set(s) for the triggered CSI-ReportConfig, e.g., the UE ignores the RRC parameter resourceSet, nzp-CSI-RS-ResourceSetList or csi-IM-ResourceSetList, or the gNB refrains from configuring resourceSet, nzp-CSI-RS-ResourceSetList or csi-IM-ResourceSetList. The gNB transmits one or more RRC messages (e.g., RRCReconfiguration message or RRCResume message) including these configurations to the UE.

In another implementation, the gNB may configure one ZP-IMR and/or one NZP-IMR associated with CMRs corresponding to a CRI combinations. Then the CMR(s) corresponding to a CRI combinations and IMR(s) may be associated in a N-to-one manner. The interference measurement operation in the embodiments above for N-to-one CMR/IMR association may be applied.

In another implementation, the gNB may configure one-to-one association for CMR and ZP-IMR, and N-to-one association for CMR and NZP-IMR.

In another implementation, the gNB may configure one-to-one association for CMR and NZP-IMR, and N-to-one association for CMR and ZP-IMR.

In an embodiment, with regard to dynamic TRP selection, where gNB may dynamically select the TRPs based on the beam quality report, e.g., layer 1 reference signal receiving power (L1-RSRP) or layer 1 signal-to-interference plus noise (L1-SINR). The gNB may dynamically activate or deactivate some CMR groups or CSI-reportConfig by MAC CE or by DCI. The MAC CE may include at least one of the following elements:
Serving cell index, which is used to indicate the serving cell index for the CSI-reportConfig
Bandwidth part index, which is used to indicate the bandwidth part index for the CSI-reportConfig
CSI report index, which is used to indicate the CSI-reportConfigId for the CSI-reportConfig,
Active CMR group index(es), which can be a bitmap to indicate the CMR group index(es) to be activated.
Transmission configuration state (TCI) index(es) for the active CMRs, which can be used to indicate the beam/quasi-co-location information for the active CMR(s)

In some implementations, the gNB and UE may determine that IMR(s) share the same activation/deactivation status as the associated CMR(s) or CMR group(s).

For DCI based dynamic activation or triggering, the gNB may configure the candidate CMR group index(es) for a triggered CSI-reportConfig corresponding to a CSI trigger state configured by CSI-AssociatedReportConfigInfo. Then by indicating a CSI trigger state in DCI field CSI request in a DCI (e.g., DCI 0_1) to trigger the UE to send a CJT-CSI report, the gNB can dynamically activate the CMR group index(es) for the CJT-CSI measurement and report.

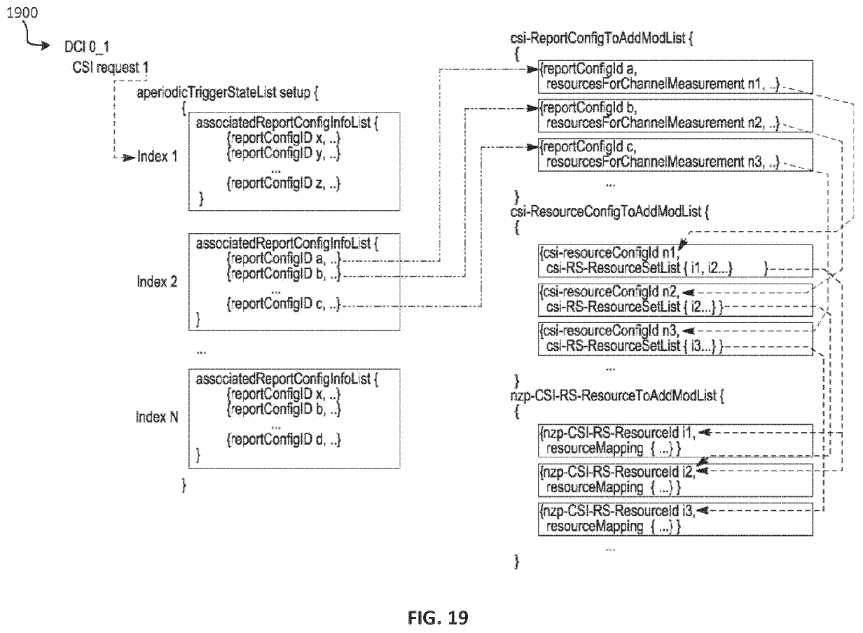

FIG. 19 illustrates an example 1900 for aperiodic CSI trigger state configuration, according to some embodiments. Example implementation for N CMR sets and 1 IMR set on the ASN.1 for aperiodic CSI report is as follows:

```
CSI-AssociatedReportConfigInfo-r18 ::= SEQUENCE {
  reportConfigId CSI-ReportConfigId,
  resourcesForChannel CHOICE {
    nzp-CSI-RS-setList SEQUENCE (SIZE (1..maxNrofAP-CSI-RS-ResourcesPerSet)) OF Nzp-CSI-RS-
Set-r18
    csi-SSB-ResourceSet INTEGER (1..maxNrofCSI -SSB-ResourceSetsPerConfig)
  },
  csi-IM-ResourcesForInterference INTEGER(1..maxNrofCSI-IM-ResourceSetsPerConfig)
OPTIONAL, -- Cond CSI-IM-ForInterference
  nzp-CSI-RS-ResourcesForInterference INTEGER (1..maxNrofNZP-CSI-RS-ResourceSetsPerConfig)
OPTIONAL, -- Cond NZP-CSI-RS-ForInterference
}
Nzp-CSI-RS-Set-r18 :: =SEQUENCE {
      resourceSet INTEGER (1..maxNrofNZP-CSI-RS-ResourceSetsPerConfig),
      qcl-info SEQUENCE (SIZE(1..maxNrofAP-CSI-RS-ResourcesPerSet)) OF TCI-StateId
                                                    OPTIONAL -- Cond Aperiodic
}
```

Example implementation for N CMR sets and N IMR sets on the ASN.1 for aperiodic CSI report is as follows:

```
CSI-AssociatedReportConfigInfo-r18 ::= SEQUENCE {
  reportConfigId CSI-ReportConfigId,
  resourcesList SEQUENCE (SIZE(1.. maxNrofNZP-CSI-RS-ResourceSetsPerConfig)) OF
CSI-AssociatedResourceConfigInfo-r18
}
CSI-AssociatedResourceConfigInfo-r18 ::= SEQUENCE {
  resourcesForChannel CHOICE {
    nzp-CSI-RS SEQUENCE {
      resourceSet INTEGER (1..maxNrofNZP-CSI-RS-ResourceSetsPerConfig),
      qcl-info SEQUENCE (SIZE (1..maxNrofAP-CSI-RS-ResourcesPerSet)) OF TCI-StateId
                                                    OPTIONAL -- Cond Aperiodic
    },
    csi-SSB-ResourceSet INTEGER (1..maxNrofCSI -SSB-ResourceSetsPerConfig)
  },
  csi-IM-ResourcesForInterference INTEGER(1..maxNrofCSI-IM-ResourceSetsPerConfig)
OPTIONAL, -- Cond CSI-IM-ForInterference
  nzp-CSI-RS-ResourcesForInterference INTEGER (1..maxNrofNZP-CSI-RS-ResourceSetsPerConfig)
OPTIONAL, -- Cond NZP-CSI-RS-ForInterference
}
```

In some implementations, the gNB can include one or more CSI-AssociatedResourceConfigInfo-r18 IE(s) in a CSI-Aperiodic TriggerStateList-r18 IE, include the CSI-AperiodicTriggerStateList-r18 in a CSI-MeasConfig IE and transmit a RRC message including the CSI-MeasConfig IE to the UE. Thus, the UE can perform CJT-CSI measurement and reporting for aperiodic CJT-CSI reporting in accordance with the CMR set(s) and one or more IMR(s) configured in the CSI-AssociatedResourceConfigInfo-r18 IE(s).

```
CSI-AperiodicTriggerStateList-r18 ::= SEQUENCE (SIZE (1..maxNrOfCSI-AperiodicTriggers)) OF CSI-
AperiodicTriggerState-r18
CSI-AperiodicTriggerState-r18 ::= SEQUENCE {
  associatedReportConfigInfoList-r18 SEQUENCE (SIZE(1..maxNrofReportConfigPerAperiodicTrigger-
r18)) OF CSI-AssociatedReportConfigInfo-r18,
  ...
}
CSI-MeasConfig ::= SEQUENCE {
  nzp-CSI-RS-ResourceToAddModList SEQUENCE (SIZE (1..maxNrofNZP-CSI-RS-Resources)) OF NZP-CSI-
RS-Resource OPTIONAL, -- Need N
  nzp-CSI-RS-ResourceToReleaseList SEQUENCE (SIZE (1..maxNrofNZP-CSI-RS-Resources)) OF NZP-CSI-
RS-ResourceId OPTIONAL, -- Need N
  nzp-CSI-RS-ResourceSetToAddModList SEQUENCE (SIZE (1..maxNrofNZP-CSI-RS-ResourceSets)) OF NZP-
CSI-RS-ResourceSet
                                                        OPTIONAL, -- Need N
  nzp-CSI-RS-ResourceSetToReleaseList SEQUENCE (SIZE (1..maxNrofNZP-CSI-RS-ResourceSets)) OF NZP-
CSI-RS-ResourceSetId
                                                        OPTIONAL, -- Need N
  csi-IM-ResourceToAddModList SEQUENCE (SIZE (1..maxNrofCSI-IM-Resources)) OF CSI-IM-Resource
OPTIONAL, -- Need N
  csi-IM-ResourceToReleaseList SEQUENCE (SIZE (1..maxNrofCSI-IM-Resources)) OF CSI-IM-
ResourceId OPTIONAL, -- Need N
  csi-IM-ResourceSetToAddModList SEQUENCE (SIZE (1..maxNrofCSI-IM-ResourceSets)) OF CSI-IM-
ResourceSet OPTIONAL, -- Need N
  csi-IM-ResourceSetToReleaseList SEQUENCE (SIZE (1..maxNrofCSI-IM-ResourceSets)) OF CSI-IM-
ResourceSetId OPTIONAL, -- Need N
  csi-SSB-ResourceSetToAddModList SEQUENCE (SIZE (1..maxNrofCSI-SSB-ResourceSets)) OF CSI-SSB-
ResourceSet OPTIONAL, -- Need N
  csi-SSB-ResourceSetToReleaseList SEQUENCE (SIZE (1..maxNrofCSI-SSB-ResourceSets)) OF CSI-SSB-
ResourceSetId OPTIONAL, -- Need N
  csi-ResourceConfigToAddModList SEQUENCE (SIZE (1..maxNrofCSI-ResourceConfigurations)) OF CSI-
ResourceConfig
                                                        OPTIONAL, -- Need N
  csi-ResourceConfigToReleaseList SEQUENCE (SIZE (1..maxNrofCSI -ResourceConfigurations)) OF
CSI-ResourceConfigId
                                                        OPTIONAL, -- Need N
  csi-ReportConfigToAddModList SEQUENCE (SIZE (1..maxNrofCSI -ReportConfigurations)) OF CSI-
ReportConfig OPTIONAL, -- Need N
  csi-ReportConfigToReleaseList SEQUENCE (SIZE (1..maxNrofCSI-ReportConfigurations)) OF CSI-
ReportConfigId
                                                        OPTIONAL, -- Need N
  reportTriggerSize INTEGER (0..6) OPTIONAL, -- Need M
  aperiodicTriggerStateList SetupRelease { CSI-AperiodicTriggerStateList }
OPTIONAL, -- Need M
  semiPersistentOnPUSCH-TriggerStateList SetupRelease { CSI-SemiPersistentOnPUSCH-
TriggerStateList } OPTIONAL, -- Need M
  ...,
  [ [
  reportTriggerSizeDCI-0-2-r16 INTEGER (0..6) OPTIONAL -- Need R
  ] ],
  [ [
  sCellActivationRS-ConfigToAddModList-r17 SEQUENCE (SIZE (1..maxNrofSCellActRS-r17)) OF
SCellActivationRS-Config-r17 OPTIONAL, -- Need N
  sCellActivationRS-ConfigToReleaseList-r17 SEQUENCE (SIZE (1..maxNrofSCellActRS-r17)) OF
SCellActivationRS-ConfigId-r17 OPTIONAL -- Need N
  ] ],
    [ [
    aperiodicTriggerStateList-r18 SetupRelease { CSI-AperiodicTriggerStateList (-r18) }
OPTIONAL, -- Need M
    ] ]
}
```

To configure CJT-CSI measurement and reporting, the gNB can transmit CSI configuration parameters: aperiodicTriggerStateList(-r18) (i.e., a list of CSI trigger states), a csi-ReportConfigtoAddModList (i.e., a list of CSI-ReportConfig IE(s)), csi-ResourceConfigToAddModList, and nzp-CSI-RS-ResourceToAddModList to the UE. The aperiodicTriggerStateList(-r18) is only applicable for aperiodic CSI report. For periodic and semi-persistent CSI report, UE follows the configurations in each CSI-ReportConfig. In some implementations, the gNB transmits at least one RRC message (e.g., RRCReconfiguration message(s) and/or RRCResume message(s)) including the CSI configuration parameters to the UE.

In some implementations, each of at least one CSI-ReportConfig IE in the csi-ReportConfigtoAddModList includes a list of CSI resources group configuration(s) configuring CMR group(s) as shown below. The following example implementations can be applied to periodic, semi-persistent and aperiodic CJT-CSI reporting.

### Example Implementation 1 of a CSI-ReportConfig IE

```
CSI-ReportConfig ::= SEQUENCE {
  reportConfigId CSI-ReportConfigId,
  carrier ServCellIndex OPTIONAL, -- Need S
  resourcesForChannelMeasurement CSI-ResourceConfigId,
  csi-IM-ResourcesForInterference CSI-ResourceConfigId OPTIONAL, -- Need R
  nzp-CSI-RS-ResourcesForInterference CSI-ResourceConfigId OPTIONAL, -- Need R
  reportConfigType CHOICE {
    periodic SEQUENCE {
      reportSlotConfig CSI-ReportPeriodicityAndOffset,
      pucch-CSI-ResourceList SEQUENCE (SIZE (1..maxNrofBWPs)) OF PUCCH-CSI-Resource
    },
    semiPersistentOnPUCCH SEQUENCE {
      reportSlotConfig CSI-ReportPeriodicityAndOffset,
      pucch-CSI-ResourceList SEQUENCE (SIZE (1..maxNrofBWPs)) OF PUCCH-CSI-Resource
    },
    semiPersistentOnPUSCH SEQUENCE {
      reportSlotConfig ENUMERATED {sl5, sl10, sl20, sl40, sl80, sl160, sl320},
      reportSlotOffsetList SEQUENCE (SIZE (1..maxNrofUL-Allocations)) OF INTEGER (0..32),
      p0alpha P0-PUSCH-AlphaSetId
    },
    aperiodic SEQUENCE {
      reportSlotOffsetList SEQUENCE (SIZE (1..maxNrofUL-Allocations)) OF INTEGER (0..32)
    }
  },
  reportQuantity CHOICE {
    none NULL,
    cri-RI-PMI-CQI NULL,
    cri-RI-i1 NULL,
    cri-RI-i1-CQI SEQUENCE {
      pdsch-BundleSizeForCSI ENUMERATED {n2, n4} OPTIONAL -- Need S
    },
    cri-RI-CQI NULL,
    cri-RSRP NULL,
    ssb-Index-RSRP NULL,
    cri-RI-LI-PMI-CQI NULL
  },
    ---other fields/IEs omitted for simplification---
    [ [
    csi-ResourcesGroupConfigList-r18 SEQUENCE (SIZE (1..N)) OF CSI-
ResourcesGroupConfig-r18 OPTIONAL, -- Need Code (e.g., N, R, M or S)
    ] ]
}
CSI-ResourcesGroupConfig-r18 ::= SEQUENCE {
  resourcesForChannelMeasurement-r18 CSI-ResourceConfigId,
  csi-IM-ResourcesForInterference-r18 CSI-ResourceConfigId OPTIONAL, -- Need R
  nzp-CSI-RS-ResourcesForInterference-r18 CSI-ResourceConfigId OPTIONAL, -- Need R
}
```

As shown in example implementation 1, the gNB can configure N CMR group(s) and/or N IMR group(s) by including the csi-ResourcesGroupConfigList-r18 including CSI-ResouresGroupConfig IE(s) 1, . . . , N in the CSI-ReportConfig IE. That is, CSI-ResouresGroupConfig IE(s) 1, . . . , N correspond to CMR groups(s) 1, . . . , N. In one implementation, the gNB and UE determine CSI-ResouresGroupConfig IE(s) 1, . . . , N with index 1, . . . , N, respectively in accordance with orders of the CSI-ResouresGroupConfig IE(s) 1, . . . , N in the csi-ResourcesGroupConfigList-r18. With this implementation, the gNB and UE may ignore or discard resourcesForChannelMeasurement, csi-IM-ResourcesForInterference, and nzp-CSI-RS-ResourcesForInterference.

### Example Implementation 2 of a CSI-ReportConfig IE

```
CSI-ReportConfig ::= SEQUENCE {
  reportConfigId CSI-ReportConfigId,
  carrier ServCellIndex OPTIONAL, -- Need S
  resourcesForChannelMeasurement CSI-ResourceConfigId,
  csi-IM-ResourcesForInterference CSI-ResourceConfigId OPTIONAL, Need R
  nzp-CSI-RS-ResourcesForInterference CSI-ResourceConfigId OPTIONAL, -- Need R
  reportConfigType CHOICE {
    periodic SEQUENCE {
      reportSlotConfig CSI-ReportPeriodicityAndOffset,
      pucch-CSI-ResourceList SEQUENCE (SIZE (1..maxNrofBWPs)) OF PUCCH-CSI-Resource
    },
    semiPersistentOnPUCCH SEQUENCE {
      reportSlotConfig CSI-ReportPeriodicityAndOffset,
      pucch-CSI-ResourceList SEQUENCE (SIZE (1..maxNrofBWPs)) OF PUCCH-CSI-Resource
    },
    semiPersistentOnPUSCH SEQUENCE {
      reportSlotConfig ENUMERATED {sl5, sl10, sl20, sl40, sl80, sl160, sl320},
      reportSlotOffsetList SEQUENCE (SIZE (1..maxNrofUL-Allocations)) OF INTEGER (0..32),
      p0alpha P0-PUSCH-AlphaSetId
    },
    aperiodic SEQUENCE {
      reportSlotOffsetList SEQUENCE (SIZE (1..maxNrofUL-Allocations)) OF INTEGER (0..32)
    }
  },
  reportQuantity CHOICE {
    none NULL,
    cri-RI-PMI-CQI NULL,
    cri-RI-i1 NULL,
    cri-RI-i1-CQI SEQUENCE {
      pdsch-BundleSizeForCSI ENUMERATED {n2, n4} OPTIONAL -- Need S
    },
    cri-RI-CQI NULL,
    cri-RSRP NULL,
    ssb-Index-RSRP NULL,
    cri-RI-LI-PMI-CQI NULL
  },
    ---other fields/IEs omitted for simplification---
    [ [
    csi-ResourcesGroupConfigList-r18 SEQUENCE (SIZE (2..N)) OF CSI-
ResourcesGroupConfig-r18 OPTIONAL, -- Need Code (e.g., N, R, M or S)
    ] ]
}
CSI-ResourcesGroupConfig-r18 ::= SEQUENCE {
  resourcesForChannelMeasurement-r18 CSI-ResourceConfigId,
  csi-IM-ResourcesForInterference-r18 CSI-ResourceConfigId OPTIONAL, -- Need R
  nzp-CSI-RS-ResourcesForInterference-r18 CSI-ResourceConfigId OPTIONAL, -- Need R
}
```

As show in example implementation 2, the gNB can configure N−1 CMR group(s) and/or N−1 IMR group(s) by including the csi-ResourcesGroupConfigList-r18 including CSI-ResourcesGroupConfig-r18 IE(s) 2, . . . , N in the CSI-ReportConfig IE. That is, CSI-ResouresGroupConfig IE(s) 1, . . . , N correspond to CMR groups(s) 2, . . . , N. In one implementation, the gNB and UE determine CSI-ResouresGroupConfig IE(s) 2, . . . , N with index 2, . . . , N, respectively in accordance with orders of the CSI-ResouresGroupConfig IE(s) 2, . . . , N in the csi-ResourcesGroupConfigList-r18. With this implementation, the gNB and UE determine resourcesForChannelMeasurement, csi-IM-ResourcesForInterference, and nzp-CSI-RS-ResourcesForInterference as CMR group 1 with index 1.

With either one of example implementations 1 and 2, the gNB can include one or more CSI-ReportConfig IEs in a csi-ReportConfigToAddModList, include the csi-ReportConfigToAddModList in a CSI-MeasConfig IE and transmit the csi-ReportConfigToAddModList to the UE. Thus, the UE can perform CJT-CSI measurements and reporting in accordance with the CSI-ReportConfig IE(s).

### Example Implementation 3 of a CSI-ReportConfig IE

```
CSI-ReportConfig-r18 ::= SEQUENCE {
  reportConfigId-r18 CSI-ReportConfigId,
  carrier-r18 ServCellIndex OPTIONAL, -- Need S
    csi-ResourcesGroupConfigList-r18 SEQUENCE (SIZE (1..N)) OF CSI-
ResourcesGroupConfig-r18 OPTIONAL, -- Need Code (e. g., N, R, M or S)
  reportConfigType-r18 CHOICE {
    periodic SEQUENCE {
      reportSlotConfig CSI-ReportPeriodicityAndOffset,
      pucch-CSI-ResourceList SEQUENCE (SIZE (1..maxNrofBWPs)) OF PUCCH-CSI-Resource
    },
    semiPersistentOnPUCCH SEQUENCE {
      reportSlotConfig CSI-ReportPeriodicityAndOffset,
      pucch-CSI-ResourceList SEQUENCE (SIZE (1..maxNrofBWPs)) OF PUCCH-CSI-Resource
    },
    semiPersistentOnPUSCH SEQUENCE {
      reportSlotConfig ENUMERATED {sl5, sl10, sl20, sl40, sl80, sl160, sl320},
      reportSlotOffsetList SEQUENCE (SIZE (1.. maxNrofUL-Allocations)) OF INTEGER(0..32),
      p0alpha P0-PUSCH-AlphaSetId
    },
    aperiodic SEQUENCE {
      reportSlotOffsetList SEQUENCE (SIZE (1..maxNrofUL-Allocations)) OF INTEGER(0..32)
    }
  },
  reportQuantity-r18 CHOICE {
    none NULL,
    cri-RI-PMI-CQI NULL,
    cri-RI-i1 NULL,
    cri-RI-i1-CQI SEQUENCE {
      pdsch-BundleSizeForCSI ENUMERATED {n2, n4} OPTIONAL -- Need S
    },
    cri-RI-CQI NULL,
    cri-RSRP NULL,
    ssb-Index-RSRP NULL,
    cri-RI-LI-PMI-CQI NULL
  },
---other fields/IEs (e.g., defined in 3GPP specificaiton 38.331) can be added---
}
CSI-ResourcesGroupConfig-r18 ::= SEQUENCE {
  resourcesForChannelMeasurement-r18 CSI-ResourceConfigId,
  csi-IM-ResourcesForInterference-r18 CSI-ResourceConfigId OPTIONAL, -- Need R
  nzp-CSI-RS-ResourcesForInterference-r18 CSI-ResourceConfigId OPTIONAL, -- Need R
}
```

As shown in example implementation 3, the gNB can configure N CMR group(s) and/or N IMR group(s) by including the csi-ResourcesGroupConfigList-r18 including CSI-ResouresGroupConfig IE(s) 1, . . . , N in a CSI-ReportConfig-r18 IE. That is, CSI-ResouresGroupConfig IE(s) 1, . . . , N correspond to CMR groups(s) 1, . . . , N. In one implementation, the gNB and UE determine CSI-ResouresGroupConfig IE(s) 1, . . . , N with index 1, . . . , N, respectively in accordance with orders of the CSI-ResouresGroupConfig IE(s) 1, . . . , N in the csi-ResourcesGroupConfigList-r18.

In some implementations, the gNB can include one or more CSI-ReportConfig-r18 IE(s) in a csi-ReportConfigToAddModList-r18, include the csi-ReportConfigToAddModList-r18 in a CSI-MeasConfig IE and transmit a RRC message including the CSI-MeasConfig IE to the UE. Thus, the UE can perform CJT-CSI measurement and reporting in accordance with the CMR set(s) and one or more IMR(s) configured in the CSI-ReportConfig-r18 IE(s).

```
CSI-MeasConfig ::= SEQUENCE {
---fields/IEs shown above are omitted for simplification---
    [ [
csi-ReportConfigToAddModList-r18 SEQUENCE (SIZE (1..maxNrofCSI-ReportConfigurations(-r18))) OF
CSI-ReportConfig OPTIONAL, -- Need N
  csi-ReportConfigToReleaseList-r18 SEQUENCE (SIZE (1..maxNrofCSI-ReportConfigurations(-r18)))
OF CSI-ReportConfigId
    ] ]
}
```

In some implementations, the IE with suffix “-r18” can be replaced with “v18xy”, where “x” and “y” can be an integer. Note, the field or IE names described above are for describing the disclosure, and the field or IE names can be changed to something like. “CMR group” and “CRM set” can be interchangeable. “IMR group” and “IRM set” can be interchangeable.

In an embodiment, for each TRP for CJT-CSI report, the gNB may provide the UE a common codebook configuration by RRC signaling, e.g., codebookConfig.

In another embodiment, for each TRP for CJT-CSI report, the gNB may provide the UE separate codebook configuration by RRC signaling. In one implementation, a codebook configuration list may be provided where each codebook configuration could correspond to each TRP. In another implementation, a common RRC signaling codebookConfig may be provided, but within this RRC structure, gNB may configure a list of some parameters in codebookConfig to provide some configuration for TRP(s) separately, e.g., numberOfPMI-SubbandsPerCQI-SubbandList, paramCombinationList and so on.

In an embodiment, to reduce UE memory for signal buffering, the gNB should refrain from configuring different periodicity or different periodicity and offset for the periodic/semi-persistent CSI-RSs from different TRPs configured for CJT-CSI measurement, where the periodicity and offset are configured by RRC signaling periodicityAndOffset. In some embodiments, UE may report its capability on whether it supports CJT-CSI measurement for periodic/semi-persistent CSI-RSs from different TRPs configured with different periodicity and/or offset. UE may further report its capability on the number of different periodicity and/or offset it can support, where this number may be lower than maximal number of TRPs for CJT operation (e.g., 4).

In addition, with regard to UE's automatic gain control (AGC) impact, the gNB transmits CSI-RSs for CJT-CSI measurement within a slot or within S consecutive slot(s), where S may be predefined or reported by UE capability from UE to gNB. Thus a common AGC factor could be applied to all the CSI-RSs.

In an embodiment, to reduce UE complexity for CSI measurement, for wideband and/or subband CJT-CSI report, the gNB should refrain from configuring different physical resource blocks (PRBs) for the CSI-RSs from different TRPs configured for CJT-CSI measurement, where the PRBs for a CSI-RS is configured by RRC signaling frequencyDomainAllocation. In some embodiments, UE may report its capability on whether it supports CJT-CSI measurement for CSI-RSs with different PRBs. UE may further report its capability on the number of different PRBs it can support, where this number may be lower than maximal number of TRPs for CJT operation (e.g., 4). In some embodiments, if the PRBs for the CSI-RSs for CJT-CSI measurement are configured to be different, UE may measurement the CJT-CSI for the common PRBs among the CSI-RSs.

In an embodiment, the gNB may configure the energy per resource element (EPRE) ratio between the PDSCH and CSI-RS from the same TRP by higher layer signaling, e.g., RRC signaling in NZP-CSI-RS-Resource, or MAC CE, or DCI. In one example, for semi-persistent CSI-RS, the EPRE ratio can be configured by the MAC CE for the semi-persistent CSI-RS activation. In another example, for aperiodic CSI-RS, different EPRE ratio can be associated with different CSI trigger state, and gNB can indicate different CSI trigger state by indicating different value of CSI request in DCI.

For antenna combining weight selection for CSI measurement for CJT, UE may construct the combined channel from all the configured TRPs based on the estimated channel as well as the power offset. In one example, for CJT from 4 TRPs, the channel can be constructed as [τ₁Ĥ₁ τ₂Ĥ₂ τ₃Ĥ₃ τ₄Ĥ₄]^{T}, where T, indicates the power scaling factor for TRP j. This power scaling factor could be determined based on the EPRE ratio between the CSI-RS and PDSCH.

### CPU Occupancy Rule and Minimal Processing Delay

UE may ignore or discard the DCI to trigger the CSI report or report an outdated CSI if the gNB's scheduling cause that the number of occupied CPUs exceed the maximum number of CPUs UE report in UE capability or the scheduling offset is smaller than minimal processing delay for CSI report. In some embodiments, UE may assume or determine such scheduling should be an error case.

In an embodiment, for CMR grouping scheme 1, e.g., CMRs in a group correspond to different TRPs as FIGS. 6 and 7, for such a CSI-reportConfig, the number of CPUs may be predefined, or determined based on the number of CMR groups and/or number of CMRs within each group.

In an implementation, the gNB and UE may assume that

$${\sum }_{k = 1}^{N} {N}_{TRP , k} + N CPUs$$

should be occupied. This CPU occupancy rule assumes that one CPU is occupied for UE to measure the precoder for one TRP, and another CPU is used to measure the cross-TRP antenna combining factor for each group and other CSI information.

In another implementation, the gNB and UE may assume that

$${\sum }_{k = 1}^{N} {N}_{TRP , k} + N CPUs$$

should be occupied. This CPU occupancy rule assumes that one CPU is occupied for UE to measure the precoder for one TRP, and one of CPUs used for per TRP precoder search can be used to measure the cross-TRP antenna combining factor for each group and other CSI information.

In another implementation, the gNB and UE may assume that S+N CPUs should be occupied, where S indicates the maximum number of different CMRs in the CSI-reportConfig. This CPU occupancy rule assumes that one CPU is occupied for UE to measure the precoder for one TRP, where UE only calculate the overlapped CMR(s) once, and another CPU is used to measure the cross-TRP antenna combining factor for each group and other CSI information.

In another implementation, the gNB and UE may assume that S CPUs should be occupied, where S indicates the maximum number of different CMRs in the CSI-reportConfig. This CPU occupancy rule assumes that one CPU is occupied for UE to measure the precoder for one TRP, where UE only calculate the overlapped CMR(s) once, and one of CPUs used for per TRP precoder search can be used to measure the cross-TRP antenna combining factor for each group and other CSI information.

In another implementation, the gNB and UE may assume that N CPUs should be occupied. This CPU occupancy rule assumes that one CPU is occupied for per CMR group, and parallel processing is not enabled within a CMR group.

In another implementation, the gNB and UE may assume that 1 CPU should be occupied. This CPU occupancy rule assumes that parallel processing is not applied.

In another embodiment, for CMR grouping scheme 2, e.g., CMRs in a group correspond to one TRP as FIG. 8, for such a CSI-reportConfig, the number of CPUs may be predefined, or determined based on the number of CMRs for each group.

In an implementation, the gNB and UE may assume that

$${\sum }_{k = 1}^{{N}_{TRP}} {M}_{k} + {\prod }_{k = 1}^{{N}_{TRP}} {M}_{k}$$

CPUs should be occupied. This CPU occupancy rule assumes that one CPU is occupied for UE to measure the precoder for one TRP, and another CPU is used to measure the cross-TRP antenna combining factor for each group and other CSI information.

In another implementation, the gNB and UE may assume that

$${\sum }_{k = 1}^{{N}_{TRP}} {M}_{k} CPUs$$

should be occupied. This CPU occupancy rule assumes that one CPU is occupied for UE to measure the precoder for one TRP, and one of CPUs used for per TRP precoder search can be used to measure the cross-TRP antenna combining factor for each group and other CSI information.

In another implementation, the gNB and UE may assume that

$${\prod }_{k = 1}^{{N}_{TRP}} {M}_{k} CPUs$$

should be occupied. This CPU occupancy rule assumes that one CPU is occupied for a CRI(s) combination processing, and with a CRI(s) combination, parallel processing is not enabled.

In another implementation, the gNB and UE may assume that 1 CPU should be occupied. This CPU occupancy rule assumes that parallel processing is not applied.

In an embodiment, the minimal processing delay for the CJT-CSI report can be predefined.

In one implementation, the minimal processing delay for CJT-CSI report can be the same as Type2 CSI report. In one example, it can be (Z2, Z2′) as defined in section 5.4 in 38.214.

In another implementation, the minimal processing delay is determined based on the maximum number of TRPs configured for the CJT-CSI report and the minimal processing delay for a Type2 CSI report. The maximum number of TRPs configured for the CJT-CSI report may be referred to the maximum number of CMR groups associated with a CJT-CSI report or the maximum number of CMR(s) in a CMR group. In one example, it can be (r*N_{TRP}*Z2, r*N_{TRP}*Z2′), where r can be in the range of (0, 1], which can be predefined or configured by RRC signaling from gNB or reported by UE capability.

In another embodiment, UE can report its capability of the minimal processing delay for the CJT-CSI report (Z, Z′).

In one implementation, UE may report multiple pairs of (Z, Z′) for different number of TRPs. For example, A UE supporting CJT for up to 4 TRPs may report 3 pairs of (Z, Z′) for 2TRP, 3TRP and 4TRP based CJT respectively.

In another implementation, UE may report one pair of (Z, Z′) regardless of number of TRPs for CJT, and the UE capability is applied to CJT-CSI report with different number of TRPs.

In another implementation, UE may report one pair of (Z, Z′) with the assumption of one number of TRPs, e.g., 2 TRPs. For CJT-CSI with different number of TRPs, the minimal processing delay may be determined based on the number of TRPs and reported (Z, Z′), e.g., it may be determined as (ceil (X/2)*Z, ceil (X/2)*Z′), where X indicates the number of TRPs configured in the CSI report. In some cases, X indicates the number of CMR groups associated with a CJT-CSI report or the number of CMR(s) in a CMR group.

Unless specifically stated otherwise, terms such as “establishing,” “receiving,” “transmitting,” or the like, refer to actions and processes performed or implemented by computing devices that manipulates data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “includes”, “including”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

### EXAMPLES

### UE Examples I

1. An apparatus, including a processer configured to cause a User Equipment (UE) to:
   a. transmit the UE capability on Channel State Information (CSI) report based the codebook for high/medium UE velocities;
   b. decode control signaling for CSI report configuration for CSI report with a codebook configured for CSI measurement based more than 1 instances for at least one CSI-RS(s) configured as channel measurement resource(s) (CMR), interference measurement resource(s) (IMR) and the time instances for CSI measurement;
   c. receive the CMRs and IMRs at corresponding time instances for CSI measurement;
   d. measure the precoder based on at least one time instance(s) of at least one CMR(s) and at least one layer indicator (LI) and/or channel quality indicator (CQI) based on at least one instance of CMR;
   e. transmit the CSI report including at least one of the measured precoder, CQI and LI.
2. The apparatus according to example 1, wherein the number of instances for a CMR for CSI measurement may be configured by RRC signaling.
3. The apparatus according to example 1, wherein the number of instances for a CMR for CSI measurement may be configured by MAC CE.
4. The apparatus according to example 1, wherein the number of instances for a CMR for CSI measurement may be configured by DCI.
5. The apparatus according to example 1, wherein the UE may report the number of instances for a CMR for CSI measurement in a CSI report.
6. The apparatus according to example 1, wherein the number of time domain basis for the codebook for high/medium UE velocities may be configured by RRC signaling.
7. The apparatus according to example 1, wherein the CSI measurement scheme may be configured by RRC signaling, where the first scheme is to measure the CSI based on actual CMR instances and the second scheme is to measure the CSI based on virtual CMR instances.
8. The apparatus according to example 7, wherein for the second CSI measurement scheme, the starting offset for the first virtual CMR instance and interval between two consecutive instances may be configured by RRC signaling.
9. The apparatus according to example 1, wherein the aperiodic CSI-RS with multiple instances may triggered by DCI.
10. The apparatus according to example 9, wherein the number of instances and interval between two consecutive instances for an aperiodic CSI-RS resource may be configured by RRC signaling.
11. The apparatus according to example 9, wherein the number of instances and interval between two consecutive instances for an aperiodic CSI-RS resource may be configured by DCI.
12. The apparatus according to example 9, wherein an aperiodic CSI resource set with CSI-RS resource from the same port(s) with an interval between two consecutive CSI-RS resources can be triggered by DCI.
13. The apparatus according to example 13, wherein whether the CSI-RS resources in an aperiodic resource set are from the same port(s) can be configured by RRC signaling.
14. The apparatus according to example 13, wherein the interval between two consecutive CSI-RS resources in an aperiodic resource set can be configured by RRC signaling.
15. The apparatus according to example 1, wherein the UE reports the LI and CQI corresponding to one CMR instance.
16. The apparatus according to example 15, wherein the CMR index may be the first or last CMR index.
17. The apparatus according to example 15, wherein the CMR index may be the configured by RRC signaling.
18. The apparatus according to example 15, wherein the CMR index may be reported by UE.
19. The apparatus according to example 1, wherein the UE reports the more than one LI and CQI corresponding to more than one CMR instance.
20. The apparatus according to example 19, wherein the UE reports the LI and CQI corresponding to each CMR instance.
21. The apparatus according to example 19, wherein the UE reports the more than one LI and CQI corresponding to CMR instance with the highest or lowest energy among the CMR instances.

### BS Examples I

1. An apparatus, including a processer configured to cause a Base Station (BS) to:
   a. decode the UE capability on Channel State Information (CSI) report based the codebook for high/medium UE velocities;
   b. transmit control signaling for CSI report configuration for CSI report with a codebook configured for CSI measurement based more than 1 instances for at least one CSI-RS(s) configured as channel measurement resource(s) (CMR), interference measurement resource(s) (IMR) and the time instances for CSI measurement;
   c. transmit the CMR(s) and IMR(s);
   d. decode the CSI report based on the corresponding CSI report configuration;
   e. determine the time instances for the CMR(s) for the decoded CSI report;
   f. identify precoder(s) and modulation and coding scheme (MCS) for physical downlink shared channel (PDSCH) transmission in a time instance based on the decoded CSI and determined time instances for CMR(s).
2. The apparatus according to example 1, wherein the number of instances for a CMR for CSI measurement may be configured by RRC signaling.
3. The apparatus according to example 1, wherein the number of instances for a CMR for CSI measurement may be configured by MAC CE.
4. The apparatus according to example 1, wherein the number of instances for a CMR for CSI measurement may be configured by DCI.
5. The apparatus according to example 1, wherein BS may decode the number of instances for a CMR for CSI measurement in a CSI report.
6. The apparatus according to example 1, wherein the number of time domain basis for the codebook for high/medium UE velocities may be configured by RRC signaling.
7. The apparatus according to example 1, wherein the CSI measurement scheme may be configured by RRC signaling, where the first scheme is to measure the CSI based on actual CMR instances and the second scheme is to measure the CSI based on virtual CMR instances.
8. The apparatus according to example 7, wherein for the second CSI measurement scheme, the starting offset for the first virtual CMR instance and interval between two consecutive instances may be configured by RRC signaling.
9. The apparatus according to example 1, wherein the aperiodic CSI-RS with multiple instances may triggered by DCI.
10. The apparatus according to example 9, wherein the number of instances and interval between two consecutive instances for an aperiodic CSI-RS resource may be configured by RRC signaling.
11. The apparatus according to example 9, wherein the number of instances and interval between two consecutive instances for an aperiodic CSI-RS resource may be configured by DCI.
12. The apparatus according to example 9, wherein an aperiodic CSI resource set with CSI-RS resource from the same port(s) with an interval between two consecutive CSI-RS resources can be triggered by DCI.
13. The apparatus according to example 13, wherein whether the CSI-RS resources in an aperiodic resource set are from the same port(s) can be configured by RRC signaling.
14. The apparatus according to example 13, wherein the interval between two consecutive CSI-RS resources in an aperiodic resource set can be configured by RRC signaling.
15. The apparatus according to example 1, wherein the BS may decode the LI and CQI corresponding to one CMR instance.
16. The apparatus according to example 15, wherein the CMR index may be the first or last CMR index.
17. The apparatus according to example 15, wherein the CMR index may be the configured by RRC signaling.
18. The apparatus according to example 15, wherein the BS may decode the CMR index in the CSI report.
19. The apparatus according to example 1, wherein the BS may decode the more than one LI and CQI corresponding to more than one CMR instance in the CSI report.
20. The apparatus according to example 19, wherein the BS may identify the LI and CQI corresponding to each CMR instance.
21. The apparatus according to example 19, wherein the BS may identify the more than one LI and CQI corresponding to CMR instance with the highest or lowest energy among the CMR instances.

### UE Example II

1. An apparatus, including a processer configured to cause a User Equipment (UE) to:
   a. transmit one or more capabilities indicating support of coherent joint transmission based channel state information (CJT-CSI) report to the base station;
   b. decode control signaling for Channel State Information (CSI) report configuration for CJT-CSI report with more than 1 configured channel measurement resources (CMRs) and at least one interference measurement resources (IMRs) associated with at least one CMR;
   c. measure the CJT-CSI based on more than 1 configured channel measurement resources (CMRs) and at least one interference measurement resources (IMRs);
   d. transmit to the base station a CJT-CSI report including index(es) corresponding to multiple CMRs as well as corresponding CJT-CSI.
2. The apparatus according to example 1, wherein the UE may report its capability on the maximum number of transmission reception points (TRPs) for CJT-CSI report, maximum number of CMRs per CJT-CSI report, maximum number of antenna ports for per CMR for CJT-CSI report, maximum number of total antenna ports across CMRs for a CJT-CSI report, maximum number of CMRs across CJT-CSI reports, and/or maximum number of CJT-CSI reports.
3. The apparatus according to example 1, wherein N CMR groups for a CJT-CSI report can be configured by RRC signaling, where N should be an integer above 0.
4. The apparatus according to example 3, wherein within a CMR group k, N_{TRP,k} CMRs from different TRPs may be configured, where N_{TRP,k} should be an integer above 1.
5. The apparatus according to example 3, wherein in a CSI report, the UE may report a CMR group index, as well as other CSI information measured from the CMR group.
6. The apparatus according to example 3, wherein other CSI information may be at least one of rank indicator (RI), precoder matrix indicator (PMI), channel quality indicator (CQI) and layer indicator (LI).
7. The apparatus according to example 5, wherein zero-power IMRs (ZP-IMRs) and non-zero-power IMRs (NZP-IMRs) may be configured in a CJT-CSI report.
8. The apparatus according to example 5, wherein a ZP-IMR and/or an NZP-IMR may be associated with a CMR.
9. The apparatus according to example 8, wherein the interference for a CMR group may be measured based on the average/minimal/maximum/total interference measured from each associated ZP-IMR and/or NZP-IMR.
10. The apparatus according to example 5, wherein a ZP-IMR and/or an NZP-IMR may be associated with a CMR group.
11. The apparatus according to example 10, wherein UE may use the spatial receiving filters used to receive the CMRs in a CMR group to receive the associated ZP-IMR and/or NZP-IMR.
12. The apparatus according to example 3, wherein the number of CSI processing units (CPUs) for a CJT-CSI report may be predefined, or determined based on the number of CMR groups and/or number of CMRs within each group.
13. The apparatus according to example 1, wherein the UE may decode the RRC signaling to configure N_{TRP} CMR groups for a CSI report, where N_{TRP} should be an integer above 1.
14. The apparatus according to example 13, wherein within a CMR group k, the gNB may configure Mₖ CMRs, where Mₖ should be an integer above 0.
15. The apparatus according to example 13, wherein zero-power IMRs (ZP-IMRs) and non-zero-power IMRs (NZP-IMRs) may be configured in a CJT-CSI report.
16. The apparatus according to example 15, wherein UE may report more than one CSI-RS resource indicators (CRIs) associated with other CSI information in a CJT-CSI report.
17. The apparatus according to example 16, wherein other CSI information may be at least one of rank indicator (RI), precoder matrix indicator (PMI), channel quality indicator (CQI) and layer indicator (LI).
18. The apparatus according to example 15, wherein a ZP-IMR and/or an NZP-IMR may be associated with a CMR.
19. The apparatus according to example 15, wherein the interference for a CMRs associated with the reported CRIs may be measured based on the average/minimal/maximum/total interference measured from each associated ZP-IMR and/or NZP-IMR.
20. The apparatus according to example 15, wherein the interference for a CMRs associated with the reported CRIs may be measured based on the average/minimal/maximum/total interference measured from each associated ZP-IMR and/or NZP-IMR.
21. The apparatus according to example 13, wherein the number of CPUs may be predefined, or determined based on the number of CMRs for each group.
22. The apparatus according to example 3 and example 13, wherein the CMR groups or a CJT-CSI report may be dynamically activated or deactivated by MAC CE.
23. The apparatus according to example 3 and example 13, wherein the CMR groups or a CJT-CSI report may be dynamically activated or deactivated by DCI
24. The apparatus according to example 1, wherein a common codebook for each TRP may be configured by RRC signaling.
25. The apparatus according to example 1, wherein separate codebook configuration for the TRPs for CJT may be configured by RRC signaling.
26. The apparatus according to example 1, wherein a common periodicity or periodicity and offset for the periodic/semi-persistent CSI-RSs from different TRPs for CJT-CSI measurement should be configured by RRC signaling.
27. The apparatus according to example 1, wherein UE receives the CSI-RSs from different TRPs for CJT-CSI measurement within a slot or within N slots.
28. The apparatus according to example 1, wherein N is an integer above 1 and can be predefined or reported by UE capability.
29. The apparatus according to example 1, wherein the CSI-RSs from different TRPs for CJT-CSI report should be configured with common physical resource blocks (PRBs).
30. The apparatus according to example 1, wherein the UE measures the CJT CSI in the common PRBs among the CSI-RSs from different TRPs for CJT-CSI report.
31. The apparatus according to example 1, wherein the energy per resource element (EPRE) ratio between the PDSCH and CSI-RS from the same TRP may be configured by RRC signaling, MAC CE, or DCI.
32. The apparatus according to example 1, wherein minimal processing delay for the CJT-CSI report can be predefined or reported by UE capability signaling.
33. The apparatus according to example 1, wherein the UE may ignore the DCI to trigger the CJT-CSI report or report an outdated CJT-CSI if the number of occupied CPUs exceeds the maximum number of CPUs UE report in UE capability or the scheduling offset is smaller than minimal processing delay for CJT-CSI report.

### BS Example II

1. An apparatus, including a processer configured to cause a Base Station (BS) to:
   a. receive one or more capabilities of a UE indicating coherent joint transmission based channel state information (CJT-CSI) report, from the UE, another base station or a core network;
   b. transmit to the UE control signaling for Channel State Information (CSI) report configuration for CJT-CSI report with more than 1 configured channel measurement resources (CMRs) and at least one interference measurement resources (IMRs) associated with at least one CMR, based on the one or more capabilities;
   c. transmit to the UE downlink reference signals configured as CMRs and IMR(s) for CJT-CSI reporting;
   d. receive a CJT-CSI report from the UE;
   e. decode the CJT-CSI report indicating index(es) corresponding to multiple CMRs as well as corresponding CJT-CSI.
2. The apparatus according to example 1, wherein the BS may decode the UE capability on the maximum number of transmission reception points (TRPs) for CJT-CSI report, maximum number of CMRs per CJT-CSI report, maximum number of antenna ports for per CMR for CJT-CSI report, maximum number of total antenna ports across CMRs for a CJT-CSI report, maximum number of CMRs across CJT-CSI reports, and/or maximum number of CJT-CSI reports.
3. The apparatus according to example 1, wherein the BS may configure N CMR groups for a CJT-CSI report can by RRC signaling, where N should be an integer above 0.
4. The apparatus according to example 3, wherein within a CMR group k, the gNB may configure N_{TRP,k} CMRs from different TRPs, where N_{TRP,k} should be an integer above 1.
5. The apparatus according to example 3, wherein in a CSI report, the gNB may receive a CMR group index, as well as other CSI information measured from the CMR group in a CJT-CSI report.
6. The apparatus according to example 5, wherein other CSI information may be at least one of rank indicator (RI), precoder matrix indicator (PMI), channel quality indicator (CQI) and layer indicator (LI).
7. The apparatus according to example 5, wherein the BS may configure at least one zero-power IMRs (ZP-IMRs) and/or non-zero-power IMRs (NZP-IMRs) in a CJT-CSI report configuration.
8. The apparatus according to example 7, wherein a ZP-IMR and/or an NZP-IMR may be associated with a CMR.
9. The apparatus according to example 7, wherein a ZP-IMR and/or an NZP-IMR may be associated with a CMR group.
10. The apparatus according to example 3, wherein the number of CSI processing units (CPUs) for a CJT-CSI report may be predefined, or determined based on the number of CMR groups and/or number of CMRs within each group.
11. The apparatus according to example 1, wherein the BS may configure N_{TRP} CMR groups for a CSI report by RRC signaling, where N_{TRP} should be an integer above 1.
12. The apparatus according to example 11, wherein within a CMR group k, the gNB may configure Mₖ CMRs, where Mₖ should be an integer above 0.
13. The apparatus according to example 11, wherein the BS may configure at least one zero-power IMRs (ZP-IMRs) and/or non-zero-power IMRs (NZP-IMRs) in a CJT-CSI report configuration.
14. The apparatus according to example 11, wherein the BS may receive more than one CSI-RS resource indicators (CRIs) associated with other CSI information in a CJT-CSI report.
15. The apparatus according to example 14, wherein other CSI information may be at least one of rank indicator (RI), precoder matrix indicator (PMI), channel quality indicator (CQI) and layer indicator (LI).
16. The apparatus according to example 11, wherein a ZP-IMR and/or an NZP-IMR may be associated with a CMR.
17. The apparatus according to example 11, wherein the number of CPUs may be predefined, or determined based on the number of CMRs for each group.
18. The apparatus according to example 3 and example 11, wherein the CMR groups or a CJT-CSI report may be dynamically activated or deactivated by MAC CE.
19. The apparatus according to example 3 and example 11, wherein the CMR groups or a CJT-CSI report may be dynamically activated or deactivated by DCI
20. The apparatus according to example 1, wherein a common codebook for each TRP may be configured by RRC signaling.
21. The apparatus according to example 1, wherein separate codebook configuration for the TRPs for CJT may be configured by RRC signaling.
22. The apparatus according to example 1, wherein a common periodicity or periodicity and offset for the periodic/semi-persistent CSI-RSs from different TRPs for CJT-CSI measurement should be configured by RRC signaling.
23. The apparatus according to example 1, wherein the BS transmits the CSI-RSs from different TRPs for CJT-CSI measurement within a slot or within N slots.
24. The apparatus according to example 1, wherein N is an integer above 1 and can be predefined or gNB may decode the UE capability on the supported value of N.
25. The apparatus according to example 1, wherein the BS may transmit the CSI-RSs from different TRPs for CJT-CSI report with common physical resource blocks (PRBs).
26. The apparatus according to example 1, wherein the energy per resource element (EPRE) ratio between the PDSCH and CSI-RS from the same TRP may be configured by RRC signaling, MAC CE, or DCI.
27. The apparatus according to example 1, wherein minimal processing delay for the CJT-CSI report can be predefined or BS may decode the minimal processing delay for CJT-CSI from a UE capability signaling.
28. The apparatus according to example 1, wherein BS may refrain decoding the CJT-CSI report if the number of occupied CPUs exceeds the maximum number of CPUs or the scheduling offset is smaller than minimal processing delay for CJT-CSI report.

What is claimed is:

1. A method of wireless communications by a user equipment (UE) device, the method comprising:
transmitting, by the UE device to a network entity, an indication of a capability of reporting a channel state information (CSI) report based on a plurality of channel measurement resources (CMRs) or signals of a plurality of transmission/reception points (TRPs) of the network entity;
receiving, from the network entity that acts in response to the indication transmitted by the UE device, a configuration message that configures the UE device to determine the CSI report;
performing concurrent measurements of the plurality of CMRs and at least one interference measurement resource (IMR) for a plurality of time instances by the UE device as configured according to the configuration message;
preparing, based on the concurrent measurements, a single CSI report that reflects time domain variation for two or more of the plurality of CMRs; and
transmitting, to the network entity, the single CSI report comprising the concurrent measurements performed.

2. The method of claim 1, further comprising:
decoding, a plurality of instances of CSI reference signals (CSI-RSes) comprising one or more of: CMRs, IMRs, and time instances for CSI measurements, with a codebook configured for CSI measurements based on the configuration message from the network entity;
obtaining a precoder value based on at least a layer indicator (LI) or a channel quality indicator (CQI) corresponding to each of the two or more of the plurality of CMRs and the at least one IMR; and
transmitting the CSI report to the network entity, the CSI report comprising the precoder and one or both of the LI and CQI.

3. The method of claim 2, further comprising:
performing concurrent measurements on the plurality of CMRs and the at least one IMR at the plurality of time instances;
determining/generating a single CSI report that reflects time domain variation for each of the two or more of the plurality of CMRs when the UE device exceeds a threshold velocity; and
transmitting the single CSI report to the network entity.

4. The method of claim 2, wherein the configuration message comprises at least one of:
a radio resource control (RRC) message;
a medium access control (MAC) control element (MAC CE); or
a downlink control information (DCI); and
wherein the plurality of instances of CSI-RSes comprises aperiodic or semi-persistent CSI-RSes.

5. The method of claim 2, wherein the indication of the capability of reporting the CSI report comprises any of:
a maximum number of instances of CSI-RS resources that the UE device is capable of measuring for the CSI report;
a number of CSI processing units (CPUs) occupied for CSI-RS with multiple instances;
an upper limit of a number of information elements (IEs) for CSI report configuration;
a minimal processing delay for the CSI report; and
whether to support CSI prediction of CSI measurements based on virtual CMR instances.

6. The method of claim 2, further comprising:
receiving a downlink control information (DCI) from the network entity for triggering the plurality of CMRs and the at least one IMR, the plurality of CMRs comprising the plurality instances of CSI-RSes.

7. The method of claim 5, wherein obtaining the precoder comprises:
identifying the instances of the CSI-RSes as the CMRs; and
performing CSI measurements on the instances of CSI-RSes.

8. The method of claim 2, wherein the configuration message comprises:
a number indicating the plurality of instances of CSI-RSes for use in the CSI report;
a number of time domain basis; and
a scheme for CSI measurements.

9. The method of claim 8, wherein the scheme for CSI measurements comprises a scheme that is based on a plurality of virtual CMRs and a plurality of physical CMRs measured before a minimal processing delay for the CSI report.

10. The method of claim 2, further comprising:
transmitting the CSI report to the network entity, the CSI report comprising multiple measurements of the LI and CQI based on:
(1) CMRs with the most energy among the plurality of CMRs or the least energy among the plurality of CMRs;
(2) a respective performance of one or more CMRs among the plurality of CMRs;
(3) the precoder;
(4) a minimal value and a maximal value of CQIs; or
(5) correspondence to a first instance and a last instance of the plurality of CMRs.

11. The method of claim 10, wherein the codebook is for decoding aperiodic CSI-RSes that are used by the UE device to report the CSI report when the UE device travels at a velocity relative to the network entity no less than a threshold velocity.

12. The method of claim 1, further comprising:
determining, based on the configuration message from the network entity, a configuration for the UE device, the configuration being used to include, in the CSI report, coherent joint transmission channel state information (CJT-CSI), wherein the CJT-CSI comprises CSI measurements of the signals from the plurality of TRPs coherently combined at the UE device through joint antenna precoding at the plurality of TRPs;
receiving the plurality of CMRs and the at least one IMR associated with one of the plurality of CMRs from the plurality of TRPs;
measuring the CJT-CSI based on the plurality of CMRs and the at least one IMR; and
transmitting the CSI report comprising one or more indices corresponding to the plurality of CMRs to the plurality of TRPs.

13. The method of claim 12, wherein the configuration message comprises at least one of:
a radio resource control (RRC) reconfiguration message; or
a system information block (SIB).

14. The method of claim 12, wherein the indication of the capability of reporting the CSI report comprises, for each component carrier (CC), each bandwidth part (BWP), each band, each band configuration, or each UE device in a group of UE devices comprising the UE device, any of:
a maximum number of TRPs that the UE device supports for the CSI report of the CJT-CSI;
a maximum number of CMRs per the configuration message for the CJT-CSI;
a maximum number of antenna ports per each of the plurality of CMRs;
a maximum number of a total number of antenna ports across the plurality of CMRs for the CSI report;
a maximum number of CMRs across multiple configuration messages (of CSI-reportConfig); and
a maximum number of the multiple configuration messages.

15. The method of claim 12, wherein:
the plurality of CMRs comprises one or more groups of CMRs across the plurality of TRPs,
the one or more groups of CMRs is configured by the configuration message, and
the CSI report comprises an index identifying one of the one or more groups of CMRs.

16. The method of claim 15, wherein the CSI report further comprises at least one of:
a rank indicator (RI);
a precoder matrix indicator (PMI);
a channel quality indicator (CQI);
a layer indicator; or
one or more CSI-RS resource indicators (CRIs).

17. The method of claim 15, wherein performing concurrent measurements comprises:
measuring the CJT-CSI when a CSI processing unit (CPU) at the UE device is available for processing the plurality of CMRs, wherein the CPU at the UE device is configured based on a total number of the one or more groups of CMRs.

18. The method of claim 17, further comprising:
determining that a trigger to include CJT-CSI in the CSI report requires a quantity of CPUs that exceeds a maximum number of CPUs included in the indication of the capability of reporting a CSI report; and
discarding the trigger or determining that the trigger corresponds to an erroneous request from the network entity.

19. The method of claim 17, further comprising
running a plurality of CPUs to perform a plurality of CJT-CST measurements in parallel for inclusion in the CSI report; wherein a quantity of the plurality of CPUs imposes a maximum number of CJT-CSI measurements that the UE device is capable of performing in parallel.

20. The method of claim 15, wherein the at least one IMR comprises one or more of a zero-power IMRs (ZP-IMRs) and non-zero-power IMRs (NZP-IMRs), and wherein the at least one IMR is associated with one of the one or more groups of CMRs.

21. The method of claim 20, further comprising:
measuring the at least one IMR with a plurality of reception beams at the UE device; or
measuring the at least one IMR across two or more CMRs in the one of the one or more groups of CMRs.

22. A method of wireless communications by a network entity, the method comprising:
receiving, from a user equipment (UE) device, an indication of a capability of reporting a channel state information (CSI) report based on a plurality of channel measurement resources (CMRs) or signals of a plurality of transmission/reception points (TRPs), the plurality of TRPs comprising the network entity;
transmitting, to the UE device responsive to receiving the indication, a configuration message that configures the UE device about the CSI report; and
receiving, at the network entity from the UE device, the CIS report comprising concurrent measurements of a plurality of channel measurement resources (CMRs) and at least one interference measurement resource (IMR) for a plurality of time instances performed by the UE device according to the configuration message.

23. The method of claim 22, further comprising receiving the CSI report from the UE device, the CSI report comprising:
a precoder used by the UE device to decode a plurality of instances of CSI reference signals (CSI-RSes) comprising one or more of: CMRs, IMRs, and time instances for CSI measurements, with a codebook configured for CSI measurements based on the configuration message; and
a layer indicator (LI) or a channel quality indicator (CQI) corresponding to each of the two or more of the plurality of CMRs and the at least one IMR.

24. The method of claim 23, wherein the configuration message comprises at least one of:
a radio resource control (RRC) message;
a medium access control (MAC) control element (MAC CE); or
a downlink control information (DCI); and
wherein the plurality of instances of CSI-RSes comprises aperiodic or semi-persistent CSI-RSes.

25. The method of claim 23, further comprising:
transmitting a downlink control information (DCI) to the UE device for triggering the plurality of CMRs and the at least one IMR, the plurality of CMRs comprising the plurality instances of CSI-RSes.

26. The method of claim 23, wherein the configuration message comprises:
a number indicating the plurality of instances of CSI-RSes for use in the CSI report;
a number of time domain basis; and
a scheme for CSI measurements.

27. The method of claim 26, wherein the scheme for CSI measurements comprises a scheme that is based on a plurality of virtual CMRs and a plurality of physical CMRs measured before a minimal processing delay for the CSI report.

28. The method of claim 23, further comprising:
receiving the CSI report from the UE device, the CSI report comprising multiple measurements of the LI and CQI based on:
(1) CMRs with the most energy among the plurality of CMRs or the least energy among the plurality of CMRs;
(2) a respective performance of one or more CMRs among the plurality of CMRs;
(3) the precoder;
(4) a minimal value and a maximal value of CQIs; or
(5) correspondence to a first instance and a last instance of the plurality of CMRs.

29. The method of claim 28, wherein the codebook is for decoding aperiodic CSI-RSes that are used by the UE device to report the CSI report when the UE device travels at a velocity relative to the network entity no less than a threshold velocity.

30. The method of claim 22, further comprising:
providing the UE device, in the configuration message, the configuration for the UE device to include coherent joint transmission channel state information (CJT-CSI) in the CSI report, wherein the CJT-CSI comprises CSI measurements of the signals from the plurality of TRPs coherently combined at the UE device through joint antenna precoding at the plurality of TRPs;
transmitting, to the UE device, at least part of the plurality of CMRs and the at least one IMR associated with one of the plurality of CMRs, among the plurality of TRPs; and
receiving the CSI report comprising one or more indices corresponding to the plurality of CMRs to the plurality of TRPs and measurements.

31. The method of claim 30, wherein the configuration message comprises at least one of:
a radio resource control (RRC) reconfiguration message; or
a system information block (SIB).

32. The method of claim 30, wherein:
the plurality of CMRs comprises one or more groups of CMRs across the plurality of TRPs,
the one or more groups of CMRs is configured by the configuration message, and
the CSI report comprises an index identifying one of the one or more groups of CMRs.

33. The method of claim 32, wherein the CSI report further comprises at least one of:
a rank indicator (RI);
a precoder matrix indicator (PMI);
a channel quality indicator (CQI);
a layer indicator; or
one or more CSI-RS resource indicators (CRIs).

34. The method of claim 32, wherein the at least one IMR comprises one or more of a zero-power IMRs (ZP-IMRs) and non-zero-power IMRs (NZP-IMRs), and wherein the at least one IMR is associated with one of the one or more groups of CMRs.

35. A user equipment (UE) comprising:
one or more radio frequency (RF) modems;
a processor coupled to the one or more RF modems; and
at least one memory storing executable instructions, the executable instructions to manipulate at least one of the processor or the one or more RF modems to perform the method of any of claims 1-21.

36. A network entity comprising:
one or more radio frequency (RF) modems;
a processor coupled to the one or more RF modems; and
at least one memory storing executable instructions, the executable instructions to manipulate at least one of the processor or the one or more RF modems to perform the method of any of claims 22-34.
